(19) United States
(12) Patent Application Publication
(10) Pub. No.: US 2002/0116263 A1
(43) Pub. Date: Aug. 22, 2002

(54) Data processing system, method and computer program, computer program and business method

(76) Inventor: Paul Gouge, Lancashire (GB)

Correspondence Address: Sheldon & Mak, 9th Floor, 225 South Lake Avenue, Pasadena, CA, 91101, US

(21) Appl. No.: 09/792,452

(22) Filed: Feb. 23, 2001

(30) Foreign Application Priority Data
Feb. 23, 2000 (GB) 0004209.3

(51) Int. Cl. G06F 17/60

(52) U.S. Cl. 705/14

(57) ABSTRACT

The present invention relates to a data processing system, method, computer program product and business method. There are many forms in which information, such as advertisements or other information, can be determinate electronically. Businesses are constantly seeking ways of exploiting the internet you increase the geographical coverage of their market. Advertising plays a significant role in extending those markets. The most common form of advertising via the internet is for a vendor of goods or services to establish a web site which can be accessed via a URL to display in a web browser of a prospective purchaser the goods and/or services offered by the vendor. This method of advertising has the advantage of being globally accessible. However, the method of advertising relies upon the prospective purchaser knowing the URL in advance of being able to locate an appropriate URL via a search engine. Many forms electronic communication are readily passed on or forwarded between friends and work colleagues. The present invention takes advantage of this fact and incorporates within any such electronic communication data representing an advertisement, when rendered by appropriate software, which can be made to vary with time by ensuring that all such electronic communications between third parties are directed and processed by a central or controlling server. Accordingly, the present invention provides data processing system comprising means for creating an outgoing email addressed to a remote server, the email having an attachment containing first data to be processed in an operation at the remote server and data representing a third party email address; means for receiving from the remote server an incoming email comprising an attachment containing second data representing the results of processing the first data; and means for displaying graphically the results of the processing. Advantageously, by ensuring that an exchange of emails between parties is always guaranteed to pass through a specific server containing the advertising information, the advertising information can be made to vary even though the e-mail carrying the advertising data is apparently passed between or directly to individuals.

### CROSS REFERENCE TO RELATED APPLICAITON

This application claims the benefit of U.K. Patent Application No. 0004209.3, entitled “Data Processing System, Method, and Computer Program, Computer Program Product and Business Method” to Paul Gouge, filed Feb. 23, 2000; the contents of which are incorporated by reference herein in its entirety.

### BACKGROUND

The present invention relates to a data processing system, method and computer program product as well as to at least one business method for the dissemination of information.

The use of computers and the Internet has increased dramatically over recent years and is emerging as a powerful means of marketing a product that any given company has to offer. Typically, when advertising products via the Internet, a company establishes a web site comprising a server and a number of publicly accessible HTML web pages. The web pages carry a description of the products and/or the services offered by that company. A prospective purchaser of a product or service must locate the server and access the web pages of the company via a URL or via a search engine which will supply such a URL. It can be appreciated that if the prospective purchaser does not have access to the required URL or the products or services of the company are not supported by a search engine, the purchaser would have difficulty in locating the server and web pages and hence the desired products or the services.

This is further complicated by the fact that as well as a purchaser having difficulty locating a supplier a supplier may not have enough information to adapt the needs of its advertising and promotion to specifically indentify a customer.

Typically, a fee is charged by the owner of an advertising medium to carry the advertisements of a third party. For example, third parties pay an appropriate fee to a Newspaper company to carry their advertisements. Similarly, television companies also typically levy a fee for carrying third party advertisements between scheduled programs. Many search engines such as, for example, Yahoo, carry advertisements of third parties for which, again, a charge is levied. There are various approaches to charging structures of Internet based advertising. In some instances, a third party pays a one-off annual payment to the search engine service provider to carry their advertisements. In other instances, the third party advertiser pays a fee to the search engine service provider every time an advertisement is accessed or found in a search performed using the search engine.

### SUMMARY

It is an object of the present invention to at least mitigate some of the above problems of the prior art.

A first aspect of the present invention provides a data processing method for a data processing system, in which the data processing system performs the steps of

receiving a first electronic communication addressed to a first addressee containing first data comprising an electronic address of a second addressee;

extracting the electronic address of the second addressee from the first data of the first electronic communication;

creating a second electronic communication addressed to the second addressee comprising data representing graphical information to be displayed to the second addressee; and

sending the second electronic communication to the second addressee using the extracted electronic address of the second addressee.

### DESCRIPTION

The following discussing describes in detail several embodiments of the invention. This discussion should not be construed, however, as limiting the invention to those particular embodiments. Practitioners skilled in the art will recognize numerous other embodiments as well. In all of the embodiments described herein that are referred to as being advantageous, preferred, or particularly preferred, these embodiments are not essential even though they may be preferred.

In contrast to the prior art, in which emails are exchanged directly between individuals which leaves no chance of varying the content of the email, the embodiments of the present invention, by terminating an email and automatically generating a second email, can amend the content or introduce content into a communication between parties. It will be appreciated that the above processing steps are performed by the data processing system automatically, that is, within human intervention in any of the steps of extracting, creating and sending.

A second aspect of the present invention is to allow information in addition to or instead of advertisements to be sent to at least the first and second addressee. Such information could be but is not limited to computer game information so that a computer game could be played between the first and second addressee which utilizes the interactive email or electronic message based data processing system described above.

Advantageously, embodiments of the present invention facilitate the accurate dissemination of information, for example, branding information and/or advertising information, to appropriate recipients. Furthermore, embodiments of the present invention disseminate information according to the characteristics of an intended recipient.

Preferably, there is provided a data processing method in which the first addressee is a data processing system, such as, for example, a Domain Name Server or remote server.

Advantageously, an embodiment provides a data processing method in which the data representing graphical information comprises third party advertising information.

A preferred embodiment provides a data processing method in which the data representing graphical information varies with time.

The time varying advertisements and branding can be targeted at specific categories of people. Accordingly, an aspect of the present invention provides a data processing method in which the first data comprises attribute data representing at least one attribute of the sender of the first electronic communication or at least one attribute of the second addressee.

Advantageously, by ensuring that an exchange of emails between parties is always guaranteed to pass through a specific server containing the information to be disseminated, that information can made to vary even though the e-mail carrying the information data is, from a user's perspective or perception, apparently passed between or directly to individuals. However, it will be appreciated that in practice passing emails “directly” between individuals means passing the email via a server other than the server containing the advertising information or that incorporates the advertising information into an email in accordance with the present invention.

Preferably, an embodiment provides a data processing method further comprising the step of selecting the data representing graphical information from a plurality of data each representing respective graphical information.

Still further, an embodiment preferably provides a data processing method further comprising the step of matching the at least one attribute with at least one of the plurality of data each representing respective graphical information, and wherein the step of creating the second email incorporates into the second electronic communication said at least one of the plurality of data representing graphical information as the graphical information to be displayed to the second addressee.

A still further embodiment provides a data processing method further comprising the step of receiving the second electronic communication; extracting the data representing graphical information and outputting the data representing graphical information via an output device.

A second aspect of the present invention provides a data processing system comprising

means for receiving a first electronic communication addressed to first addressee containing first data comprising an electronic address of a second addressee,

means for extracting the electronic address of the second addressee from the first electronic communication;

means for creating a second electronic communication addressed to the second addressee comprising data representing graphical information to be displayed to the second addressee; and

means for sending the second electronic communication to the second addressee using the extracted electronic address of the second addressee.

It will be appreciated from the above that the invocation of the various means which form part of the data processing system according to embodiments of the present invention occurs automatically, that is, without human intervention in relation, in particular, to the invocation of the means for extracting, means for creating and means for sending. In effect, an incoming email is automatically terminated at the server, a new email is created using information contained within the terminated email and automatically transmitted, with or without additional information being incorporated into the email, to an identifiable address.

A third aspect of the present invention provides a computer program product comprising a computer readable storage medium having stored thereon

computer program code means for receiving a first electronic communication addressed to first addressee containing first data comprising an electronic address of a second addressee,

computer program code means for extracting the electronic address of the second addressee from the first electronic communication;

computer program code means for creating a second electronic communication addressed to the second addressee comprising data representing graphical information to be displayed to the second addressee; and

computer program code means for sending the second electronic communication to the second addressee using the extracted electronic address of the second addressee.

A fourth aspect of the present invention provides a computer program element comprising

computer program code means for receiving a first electronic communication addressed to first addressee containing first data comprising an electronic address of a second addressee,

computer program code means for extracting the electronic address of the second addressee from the first electronic communication;

computer program code means for creating a second electronic communication addressed to the second addressee comprising data representing graphical information to be displayed to the second addressee; and

computer program code means for sending the second electronic communication to the second addressee using the extracted electronic address of the second addressee.

A further aspect of the present invention provides an interactive email based data processing system comprising a server (battle mail server) for processing data contained within a first email (challenger email) received from a sender to produce a second email containing a number of options to be selected by a recipient (opponent) identified in the data (attachment); means (outgoing mail server) for sending the second email to the identified recipient (opponent); means (incoming mail server) for receiving a third email from the identified opponent containing data relating to the number of options; means (battle mail console software) for processing the data contained within the first and third emails; means (battle mail console software) for constructing a fourth email containing the results of that processing; and means (outgoing mail server) for sending the fourth email to at least one of the sender (challenger) and recipient (opponent).

An embodiment of the present invention provides means (battle mail console software and database) for retrieving from an information database (database) information, for example an advertisement, to be incorporated into at least one of the second and fourth emails.

An embodiment provides data processing system in which the means for retrieving information from the information data base is responsive to data associated with at least one of the sender (challenger) or/and recipient (opponent).

In a preferred embodiment, the retrieved information is an advertisement for a product and/or services or a website in which it is reasonably anticipated that the sender or recipient would be interested.

A further embodiment provides a data processing system wherein the means for retrieving information retrieves data for an active element, for example, a GIF file or an applet to be displayed to at least one of the sender (challenger) or recipient (opponent).

Advantageously, embodiments of the present invention allow the advertisements to be time varying which allows the charging structure to take into account the time of day at which an advert is carried by the emails generated by the embodiments of the present invention. Still further, the advertisements also vary according to the target market, that is, with the characteristics of the user. This allows the charging structure for carrying the advertisements to reflect the target market.

Emails carrying interesting information such as an amusing image or passage of text are readily exchanged between colleagues. It can be appreciated that an advertisement carried in such a manner or associated with such a means of disseminating information would be fixed and unable to be matched on a dynamic basis to the characteristics of an addressee.

Accordingly, a further advantage of embodiments of the present invention is that by ensuring all emails are exchanged between a parties via the same central server, the advertisements, branding or information displayed to the challenger and the opponent can be made dynamic, in the sense that the advertisements can be changed from time to time. It can be appreciated that the conventional means of exchanging emails between parties cannot ensure that those emails are routed via the specific server that can process the emails to include advertising information. In the absence of routing email via such a specific server, the advertising information cannot be included and/or cannot be varied over time or according to the characteristics of the parties to the email.

Advantageously, embodiments of the present invention allow information in addition to or instead of advertisements to be sent to at least the first and second addressee. Such information could be but is not limited to computer game information so that a computer game could be played between the first and second addressee which utilises the interactive email or electronic message based data processing system described above.

Further advantageous features are described in appended claims.

### FIGURES

Embodiments of the present invention will now be described, by way of example only, with reference to the accompanying drawings in which

FIG. 1 illustrates schematically a data processing system upon which embodiments of the present invention can be realized;

FIG. 2 shows in greater detail the data processing architecture of the hardware upon which embodiments of the present invention can be realized;

FIG. 3 illustrates the flow of data between the elements of FIG. 1 according to an embodiment;

FIG. 4 illustrates schematically the battle mail data entities of an embodiment;

FIG. 5 shows an initialisation screen of a user who has installed the battle mail console software;

FIG. 6 shows a registration screen for a first time user of the battle mail console software

FIG. 7 shows a confirmation screen of the data entered in FIG. 6;

FIG. 8 shows illustrates a new challenge request initialization screen of a user who has installed the battle mail console software;

FIG. 9 illustrates a select fighter screen;

FIG. 10 illustrates a “Select Attack Moves” screen by which a challenger or opponent selects attacking moves for a character;

FIG. 11 illustrates a “Select Defend Moves” for a character selected by the challenger or an opponent;

FIG. 12 illustrates the entry of a “Victory Cry” screen;

FIG. 13 shows a confirmation of challenge screen;

FIG. 14 illustrates the sponsorship exit screen;

FIG. 15 illustrates, in C++, the data that is the data collated and forming the attachment for an outgoing email;

FIGS. 17 and 18 illustrate a “Previous Challenge” and an “Incoming Challenge!” screen received by an opponent respectively;

FIG. 19 illustrates the “Get Ready!” screen;

FIG. 20 illustrates an instance of “The Arena” screen depicting the exchange between a challengers character and an opponents character;

FIG. 21 illustrates the end of the fight and the use of “The Victory Cry” together with a Victory dance;

FIG. 22 illustrates the assignment of points to a character;

FIG. 23 illustrates the award of another belt level to a user;

FIG. 24 illustrates the assignment of additional experience points to a character's fighting ability;

FIG. 25 illustrates a decision flow chart illustrating the selection of information for an outgoing email;

FIG. 26 shows a further embodiment of the present invention which uses mobile communication devices;

FIG. 27 illustrates a heterogeneous system in which exchanges between various hardware platforms are supported;

FIG. 28 depicts schematically the structure of a mobile communication device according to an embodiment;

FIG. 29 illustrates the exterior of a mobile telephone according to an embodiment;

FIGS. 30a, 30b and 30c shows various initial screen of an embodiment;

FIG. 31 shows a flowchart for issuing a challenge according to an embodiment;

FIG. 32 depicts a select character screen according to an embodiment;

FIG. 33 depicts a select attacking moves according to an embodiment;

FIG. 34 illustrates a select defensive moves according to an embodiment;

FIG. 35 shows a enter victory cry screen according to an embodiment;

FIG. 36 depicts a screen for selecting an opponent according to an embodiment;

FIG. 37 shows a send challenge screen according to an embodiment;

FIG. 38 depicts a challenge send screen according to an embodiment;

FIG. 39 illustrates an inbox selection screen according to an embodiment;

FIG. 40 shows a select opponent screen according to an embodiment;

FIG. 41 shows an accept challenge screen according to an embodiment;

FIG. 42 depicts a select character screen for an opponents according to an embodiment;

FIG. 43 shows an enter attacking moves screen for an opponents according to an embodiment;

FIG. 44 depicts an enter defensive moves screen for an opponents according to an embodiment;

FIG. 45 illustrates an enter victory cry screen for an opponents according to an embodiment;

FIG. 46 shows a send acceptance of challenge screen for an opponents according to an embodiment;

FIG. 47 depicts an acceptance send screen for an opponents according to an embodiment;

FIG. 48 shows a further select inbox screen for an opponents according to an embodiment;

FIG. 49 depicts a view fight screen for an opponents according to an embodiment;

FIG. 50 illustrates a further splash screen for an opponents according to an embodiment;

FIG. 51 shows a combatants screen for an opponents according to an embodiment;

FIG. 52 illustrates an arena screen for an opponents according to an embodiment;

FIG. 53 shows a victory celebration screen according to an embodiment;

FIG. 54 shows a victory cry screen according to an embodiment;

FIG. 55 illustrates a save fight screen according to an embodiment;

FIG. 56 illustrates the various hardware platform exchanges that can be realized using embodiments of the present invention or to realize embodiments of the present invention.

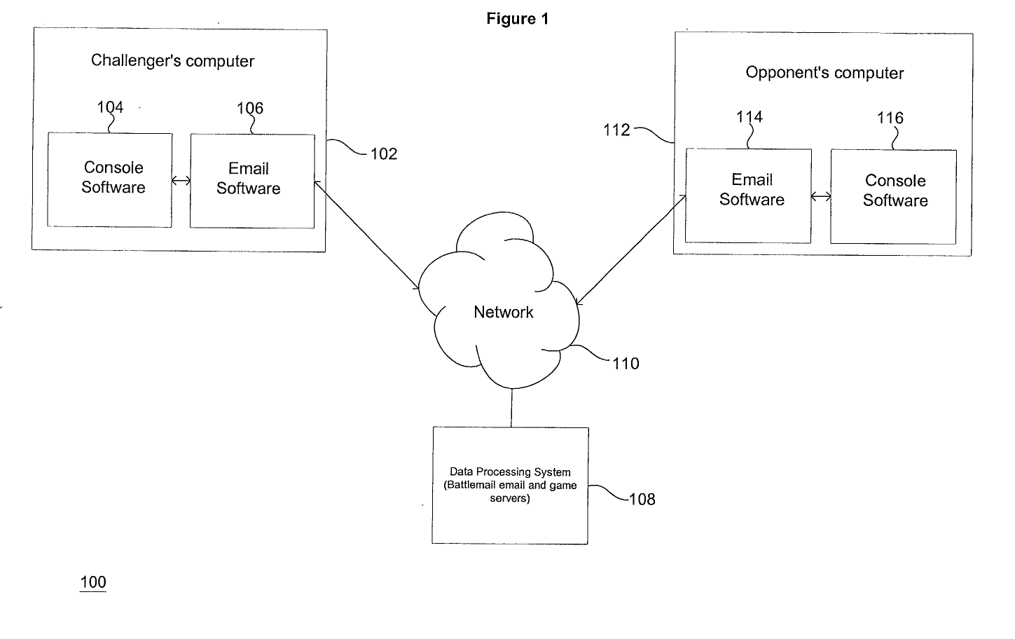

Referring to FIG. 1 there is shown in schematic form the basic components of an embodiment of the present invention. A first user, challenger (not shown), using a computer 102 having battle mail console software 104 and email software 106, such as Microsoft Outlook, issues a challenge to an opponent by sending an email to a remote data processing system including a mail server 108 via a communication network 110. The email contains data identifying the opponent and data collated by the console software 104 from inputs of the challenger such as, for example, a challenger's selected character and moves. The remote mail server, in effect, forwards the challenge to another user's computer 112, that is, to an opponent's computer. However, in practice, the incoming email to the remote mail server 108 sent from the first computer 102 is terminated and a new outgoing email from the remote mail server 108 is generated and forwarded by the remote mail server to the ultimate addressee, that is, the opponent. The opponent's computer 112 also comprises proprietary email software 114 which receives and processes the email sent from the remote mail server 108. The data contained within the email sent from the remote mail server 108 to the opponent's computer 112 is extracted and processed by the battle mail console software 116 that is resident on the opponent's computer 112. In an embodiment, the proprietary email software may be Microsoft Outlook. Although the challenge appears from a user's perspective to be forwarded by the data processing system 108, the first email containing the challenge is terminated at the remote mail server 108 and a new email is created that is addressed to the opponent using a separate email and transmitted by the remote server 108.

The results of processing the data contained within the email sent from the remote mail server 108 by the battle mail console software 116 are output to the user, that is, the opponent. The results comprise information, such as, for example, an advertisement, in addition to the graphical data relating to images created as a consequence of playing the game.

The opponent is expected to respond to the data processing results output by the battle mail console software 116. The battle mail console software 116 processes the opponent's response and causes the email software 114 to send an email via the communication network 110 to the remote mail server 108. This email contains data representing the opponent's response to the incoming email and data identifying the first addressee or at least data from which the first addressee can be identified or from which the incoming email to the remote mail server can be matched with the challenger's email. In a preferred embodiment, a unique identifier is assigned to every incoming email to the server 108. The unique identifier is also associated within any outgoing emails transmitted from the server 108 which relate to the incoming email. The console software 104 and 116 is arranged to ensure that outgoing emails for a particular exchange use the unique identifier to allow the remote server 108 to correlate challenge and response emails.

The remote mail server 108 processes the data contained within both the email received from the challenger and the email received from the opponent to produce data processing results that are dependent upon the challenger's data and the opponent's data. The remote mail server 108 constructs a further email containing data, including the data processing results, and forwards that further email to both the challenger's computer and the opponent's computer. The further email is processed by the respective battle mail console software 104 and 116 the outcome of the processing by the remote mail server 108 is displayed to the challenger and opponent.

In an embodiment, the remote mail server 108 additionally retrieves, from an information database, information to be forwarded to the opponent and/or the challenger. The respective battle mail console software 104 and 116 at the challenger's computer 102 and the opponent's computer 112 is arranged to display this additional information for viewing by the challenger and/or the opponent. The information may comprise at least one of advertising information, branding or marketing information.

Preferably, every outgoing mail message from the battle mail server (remote mail server) 108 contains such retrieved information.

In a preferred embodiment, the retrieved information represents an advertisement for third party products and/or services or branding or sponsorship information. In an embodiment, when an advertisement for third party products and/or services is rendered at the challenger's computer 102 or the opponent's computer 112, a hyperlink, embedded within the advert or information, is also displayed at the corresponding computer which allows the user of the computer to connect to a website of the third party whose advertisement has been displayed.

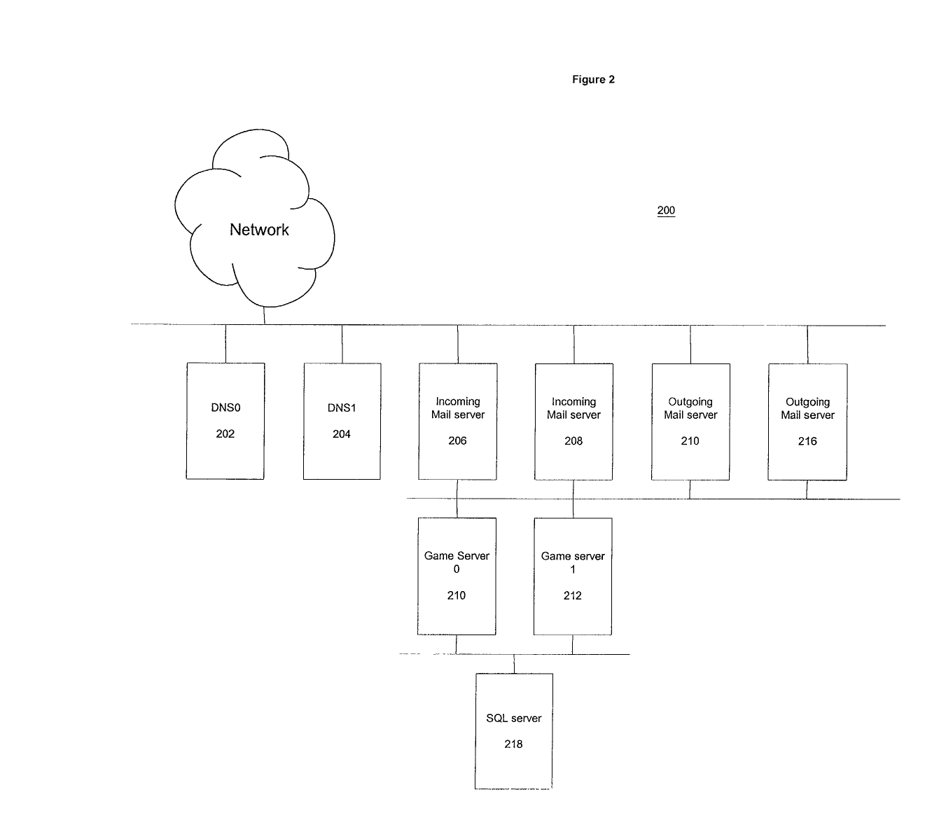

Referring to FIG. 2 there is shown a data processing architecture, which can be used to realize embodiments of the present invention. Incoming mail is directed by a pair of Domain Name Servers 202 and 204 to one of a plurality of incoming mail servers 206 and 208. In effect, although, from a user's perspective, an outgoing email appears to be addressed to an intended recipient, in practice, the outgoing mail is addressed to one of the Domain Name Servers 202 and 204. Preferably, a load-balancing scheme is utilized to ensure a balanced throughput of received mail. Each email, comprising an attachment having a structure described hereafter, is processed by the incoming mail servers 206 and 208 to remove that attachment from an incoming email and to forward that removed attachment to one of a pair of game servers 210 and 212. The attachment is transferred using, for example, a TCP/IP connection to one of the game servers 210 and 212. When the attachment has been transferred, the TCP/IP connection is dropped. The game servers 210 and 212 process the data contained within the attachment and form an attachment for an outgoing email which is passed for inclusion into the outgoing email to one of the pair of outgoing mail servers 214 and 216. A data base server 218 is used to store advertising data of third parties and the data for the battle mail entity as shown in FIG. 4 hereafter.

The attachment, a BMD file, is attached to an email in the conventional manner, that is, the Microsoft Windows Messaging System, SMAPI, is used to both create the email in the Microsoft Outlook Outbox and to attach the BMD data file to the newly created email.

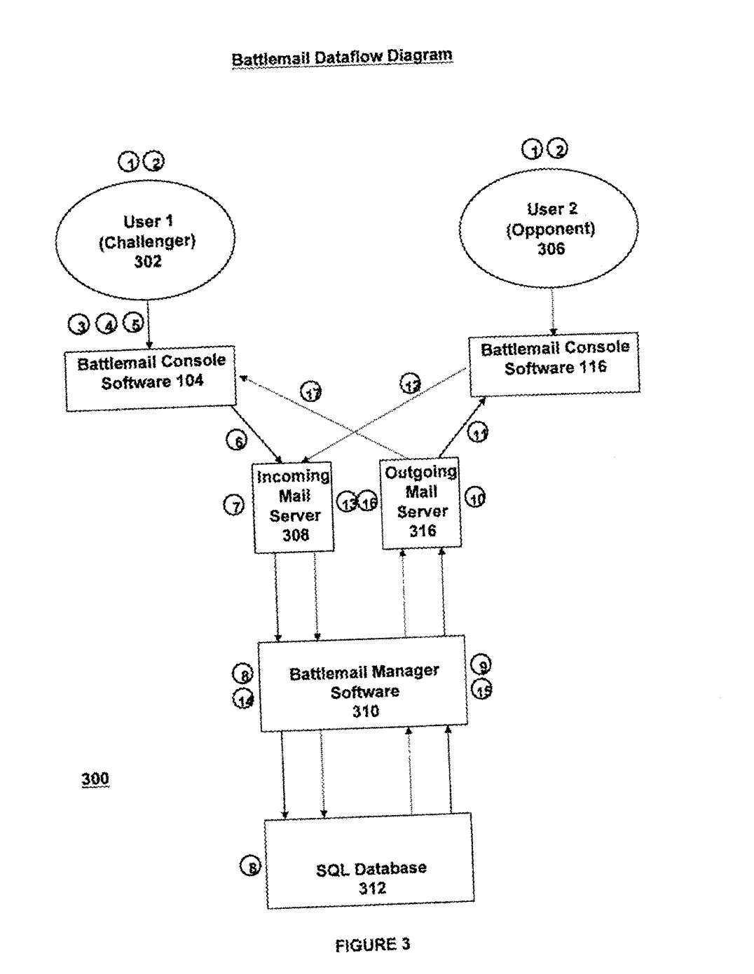

Referring to FIG. 3 as there is shown schematically a data flow diagram of an embodiment of the present invention. A user (challenger) 302 uses the battle mail console software 104 to issue a challenge to an opponent 306 using a selected fighting character (not shown) . The challenge is issued via an email that is directed to an incoming (remote) mail server 308 which, as shown in FIG. 2, is realized using a pair of Domain Name Servers 202 and 204 and two incoming mail servers 206 and 208. The attachment of the incoming email is processed by the battle mail manager software 310 which examines the characteristics or profile of the challenger and/or the opponent (if the profile of the opponent is already know) and retrieves suitable advertising material from The data base database 312. The battle mail manager software 310 creates an outgoing email having an attachment (not shown) which is addressed to the opponent 306. The attachment (not shown) contains data relating to the challenger and the retrieved information such as, for example, branding or advertisement(s). The email together with the attachment is addressed to the battle mail console 116 via an outgoing mail server 316. It will be appreciated that the outgoing mail server 316 is realized, as can be appreciated from FIG. 2, using two outgoing mail servers 210 and 216. The battle mail console displays the challenge to the user, that is, the opponent 306.

The opponent replies to the challenge by selecting a preferred fighting character and attacking and defensive moves. The opponent 306 sends an email with an attachment containing details of the response of the challenge to the incoming mail server 308, that is, to the same mail server from which the challenge, at least notification of the challenge, was issued. The battle mail manager software extracts the data contained within the incoming email from the opponent, matches that data with the corresponding data of the challenger and determines the outcome of the battle between the respective selected characters of the challenger and the opponent. Preferably, the battle mail manager software retrieves from The data base database 312 advertising information that is matched to a profile of at least one of the challenger and/or the opponent. Preferably, the advertising information is matched to both the challenger and the opponent. Alternatively, the battle mail manager software 310 can retrieve information that is matched to the challenger and to the opponent respectively. The battle mail manager software 310 causes the outgoing mail server 316 to forward to the challenger and opponent an email containing an attachment with data reflecting the outcome of the battle between the challenger's selected character and the opponent's selected character together with the advertising information. The respective battle mail console software 104 and 116 of the challenger 302 and opponent 306 causes the characters to enact the battle and also causes the advertising information extracted from The data base database 312 to be displayed to the challenger 302 and opponent 306.

Although the embodiments described herein relate to a battle, that is, a combat sequence, being enacted between characters, the present invention is not limited thereto. Embodiments can be realized in which the exchange between the parties relates to some other form of engagement or competition, such as, for example, a penalty shoot out, a multi-player tournament, sponsorship or fighting type games.

Referring to FIG. 4, there is shown the relationship between the data entities used within an embodiment of the present invention. A BM Player data entity 402 is created for each of the participants in a battle, that is, for the challenger and the opponent.

The BMPlayer data entity reflects the details of a user. The BMPlayer data entity field active 404 is used to indicate whether or not the participant identified in the data structure BMPlayer is allowed to participate in Battlemail games. The active flag 404 can be used to selectively prevent users from taking part in Battlemail games.

The data entity AgeBand 406 is used to provide an indication of the age range within which a corresponding party identified by the BM Player data entity 402 falls. The data entity country 408 is used to determine the country within which the player identified by the BM Player data entity 402 resides. The gender data entity 410 is used to identify the gender of the player whose details are stored in the BM Player data entity 402.

The data entities AdAgeBand 412, AdCountry 414 and AdGender 416 are used to access information such as, for example, branding or adverts, stored in a data base of adverts 418 that are appropriate to the age band, country and gender of the current player identified by the Battle mail data entity 402 to 410. Each advert stored within The data base Server has a plurality of data fields associated with it. Each advertisement has an advertisement code, add code 420, that is used as a key for accessing the advert associated with the data entity advert 418. There is also provided data entity ACode 422 that is described hereafter in greater detail. A text description corresponding to any given advert is stored in the description field 424. A flag, active 426, that is used to indicate whether or not a corresponding advertisement is active, that is, whether or not a corresponding advertisement is allowed to be output to the Battlemail participants. An advertisement may be deemed to be active between particular dates. In such an embodiment two variables containing respective dates are used to determine the dates between which an advert is active. These variables are ActiveDateFrom 428 and ActiveDateTo 430.

A data entity image location 432 is used to determine the location, that is which information display field, within the screens output to a user the corresponding advertisement information should be displayed.

A field or flag, AllowAnyProfile, 434 is used to indicate whether the advert is suitable for all parties regardless of their age band, country or gender.

The variables ActiveWindowFrom 436 and 438 are used to indicate the time of day during which corresponding information can be displayed through a user or incorporated into a data attachment.

With each advert, there is also associated advertiser details. The advertiser details are accessed using the key ACode 420 which is extracted from a corresponding advert data entity 418 and is used to access a database of advertisers. For each advertiser, contact details such as the name, address, phone number, fax and e-mail are stored in the advertiser data entity 440. A data entity AdLog 442 is stored for each advert. The AdLog data entity is used to produce a file of details providing an indication to whom an identifiable information such as adverts or branding has been displayed. The AdLog data entity and AdLog file are used to allow or to facilitate billing according to an agreed billing structure.

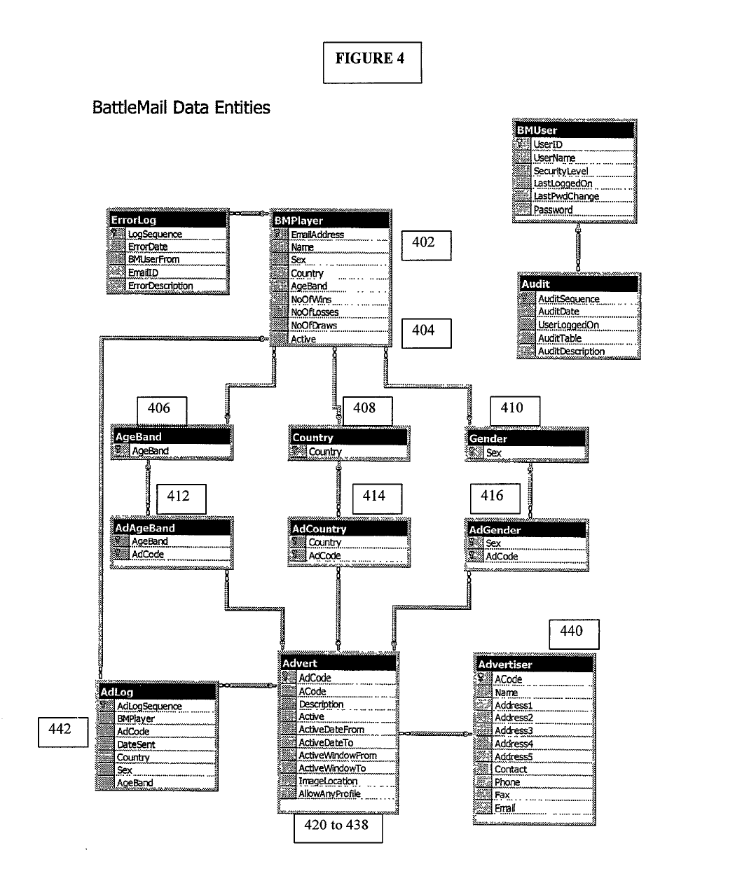

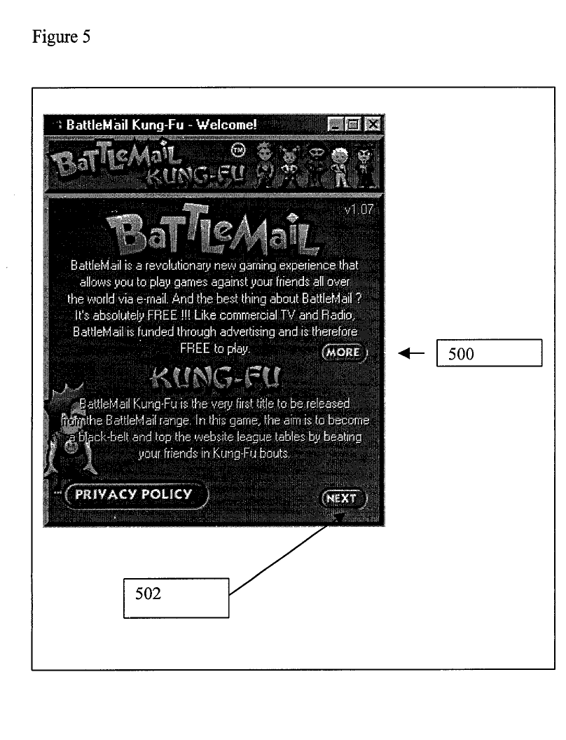

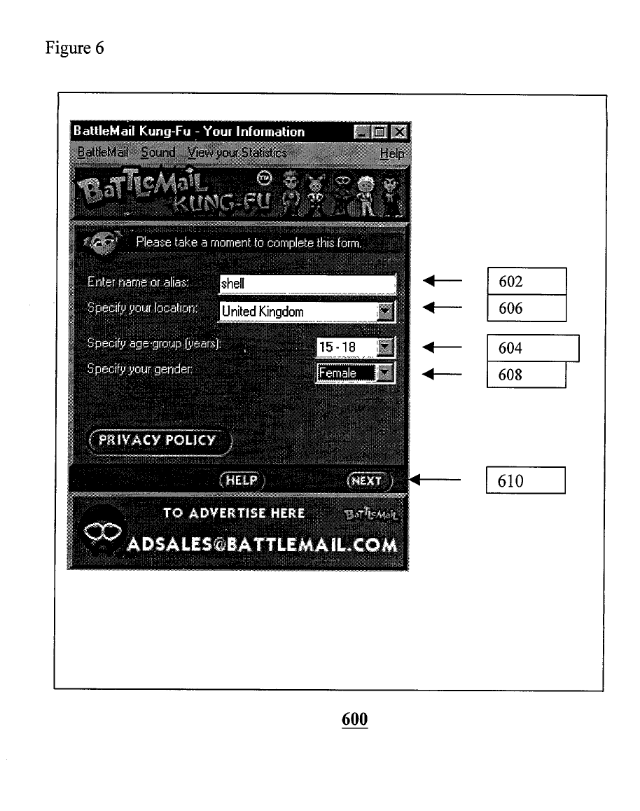

Referring to FIG. 5 as there is shown an “Welcome!” screen that is output to a user who has just installed or invoked the battle mail console software 104 or 116. The “Welcome!” 500 screen describes the fundamental aim of battle mail and leads, via a “Next” button 502 to an initialisation screen entitled “Your Information” as shown in FIG. 6. FIG. 6 illustrates a “data capture” screen that is used to collate personal data related to the characteristics of a user. The user enters personal data in a number of fields of the “data capture” screen. It can be seen that the name “shell” has been entered in the “Enter name or alias” box 602.

In an embodiment, the invention is email based. Therefore, the personal email address for the user is required. Further characteristics relating to the user are entered via boxes 604 to 608. For example, the age of the user is entered by selecting an appropriate range using a pull down menu 604. The country in which the user resides is selected using a further pull down menu 606 and the gender of the user is specified using a third pull down menu 608. The country of residence can be used to direct challenge emails issued by a challenger or response emails issued by an opponent to a conveniently located Battlemail server 104. A “Next” button 610 is provided to take the user to the following screen as shown in FIG. 7.

Optionally, the “Your Information” screen 600 may comprises a check box which can be unchecked if the user does not wish to receive further news or correspondence from the game service provider.

Referring to FIG. 7, it can be appreciated that the user is being requested to confirm via a confirmation screen 700 that the details entered using the data capture screen is correct using “YES” 702 and “NO” 704 buttons. Selecting “YES” 702 button leads the user to the following screen which allows the user to issue a challenge, as can be seen from Figure D.

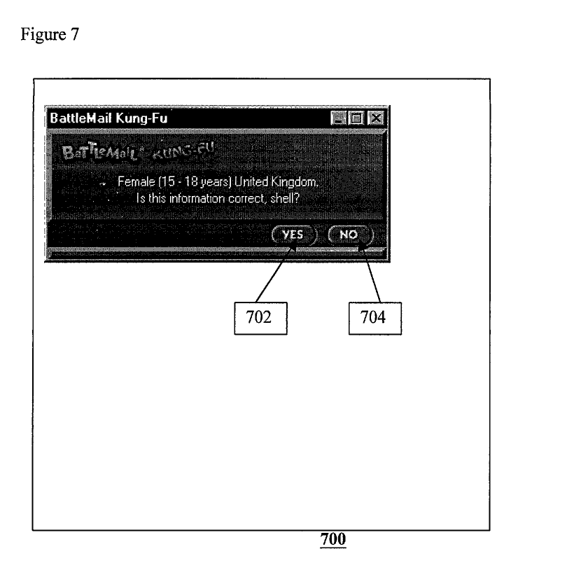

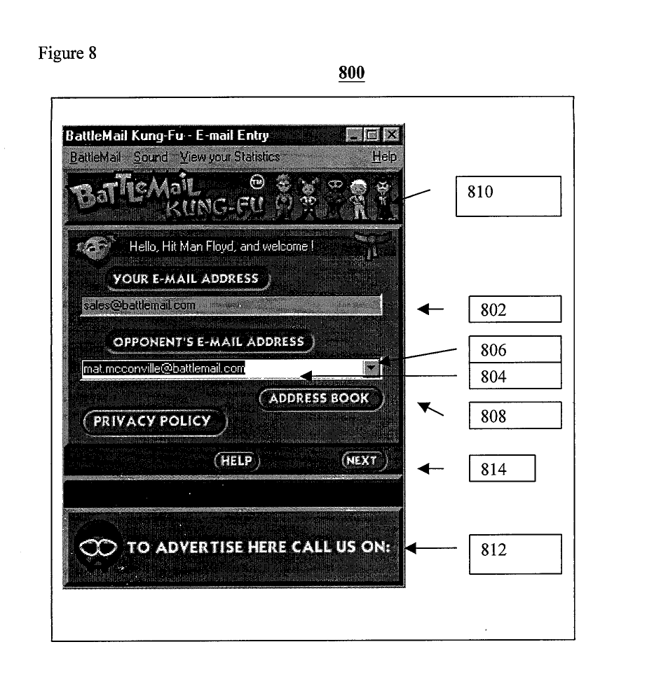

The user has selected the “Yes” button 702 the user is taken to a further information capture screen 800 as shown in FIG. 8. The further information capture screen 800 is entitled “E-mail Entry” and comprises a number of fields including the email address of the challenger 802 and the email address of the potential opponent 804. This screen also provides the option of using a pull-down menu 806 which comprises a list of potential opponents (not shown) from which a potential opponent can be selected. Preferably an address book 808 is provided, again, to allow a potential opponent to be selected. Preferably, the screen 800 also comprises at least one, and preferably two, information display areas 810 and 812. The screen also comprises a “Next” button 814 which takes the user to the next screen or the next stage of the process.

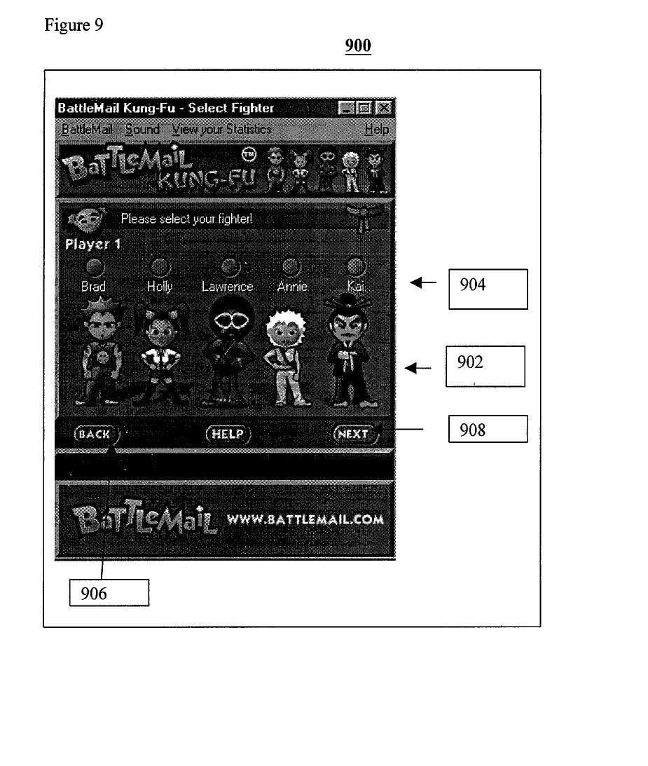

The next screen 900, as can be seen from FIG. 9, allows the challenger to select a fighter to represent the challenger. It can be seen that the screen comprises a plurality of potential characters 902 that can be selected using corresponding buttons 904 located above each character. The “Select Fighter” screen 900 comprises a “Back” button 906 via which the user is returned to the previous screen and a “Next” 908 button via which the user is taken to the following screen.

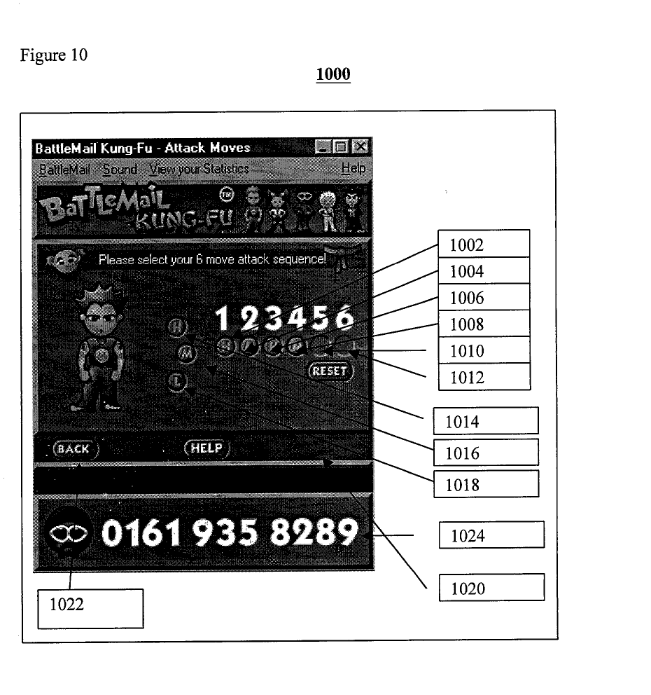

An “Attack Moves” screen 1000 is presented to the user once the above “Next” button 908 has been depressed as can be seen from FIG. 10. Having selected a fighter using an appropriate one of the buttons 904, the selected character is displayed while the attacking moves are being selected. The attacking moves for the character to undertake are entered using the buttons 1002 to 1012. It can be appreciated that six moves can that for each of the six moves selected, the move must be designated as a high, middle or low attack using the three 1014, 1016 and 1018.

The user, having selected the six attacking moves, progresses to the next screen using a “Next” button 1020, which although not shown in FIG. 10 appears once six moves have been entered. The user can return to the previous screen via a “Back” button 1022. Preferably, FIG. 10 also comprises an information display field 1024 via which information relating to, for example, third party products or services, advertisement and/or branding or sponsorship information, can be displayed.

Each attack has associated with it, in an embodiment, a base value and a maximum level. The base value determines the amount of damage inflicted on an opponent via a successful attack using the corresponding move. The maximum level provides an indication of the maximum damage that can be inflicted upon an opponent by a corresponding attack.

Table 1 below illustrates for each of the possible attacks and stamina the associated base value and maximum level value.

TABLE ONE

| Skill | Base Value | Max. Level | Description |
|---|---|---|---|
| High attack | 4 | 9(+5) | determines the amount |
| | | | of damage inflicted on |
| | | | an opponent with a |
| | | | successful high attack |
| | | | move |
| Mid attack | 4 | 9(+5) | determines the amount |
| | | | of damage inflicted on |
| | | | an opponent with a |
| | | | successful mid attack |
| | | | move. |
| Low attack | 4 | 9(+5) | determines the amount |
| | | | of damage inflicted on |
| | | | an opponent with a |
| | | | successful low attack |
| | | | move. |
| High | 4 | 9(+5) | determines the amount |
| counter | | | of damage inflicted on |
| attack | | | an opponent with a |
| | | | successful high |
| | | | counter attack |
| Low counter | 2 | 9(+5) | determines the amount |
| attack | | | of damage inflicted on |
| | | | an opponent with a |
| | | | successful low counter |
| | | | attack |
| Stamina | 20 | 30(+10) | determines the amount |
| (energy) | | | of stamina (energy) |
| | | | with which a player |
| | | | will start the game |

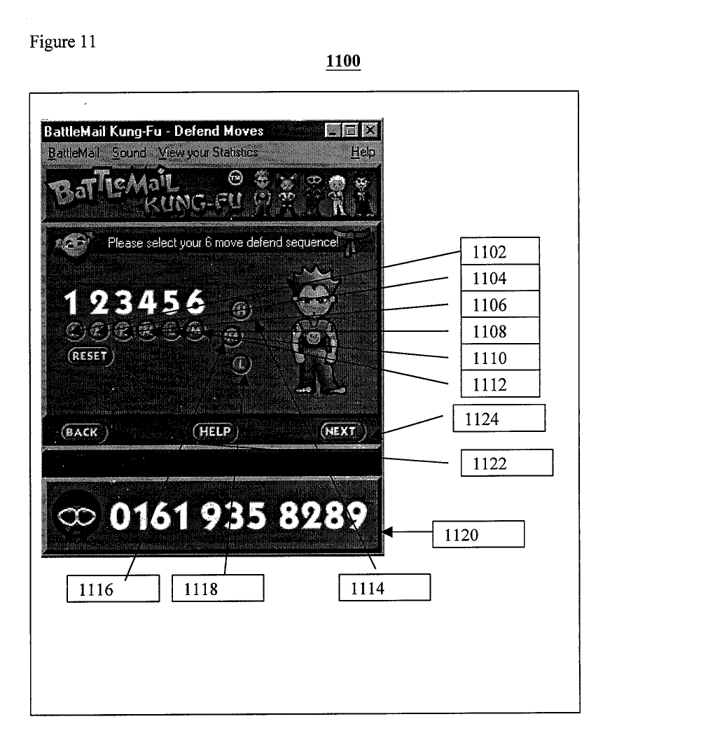

Selecting the “Next” button 1020 of FIG. 10 takes the user to the “Defend Moves” screen 1100 as shown in FIG. 11 via which the user selects a predeterminable number of anticipatory defensive moves for the fighter to undertake in defence to a challenger's attacking moves.

The defensive moves entered for the character to undertake are entered using the buttons 1102 to 1112. It will be appreciated, as with the selection of the attacking moves, that the anticipatory defensive moves can be defensive high, middle, low moves. The level of the defensive moves is selected using a plurality of buttons 1114, 1116 and 1118 which correspond to high, middle and low defensive moves respectively.

Each defensive move has associated with it, in an embodiment, a base value and a maximum level. The base value determines the degree of mitigation of that move against a corresponding attacking move. The maximum level provides an indication of the maximum degree of such mitigation of the corresponding defensive move against a corresponding attack.

Table two below illustrates for each of the possible defensive moves and stamina the associated base value and maximum level value.

TABLE TWO

| Skill | Base Value | Max. Level | Description |
|---|---|---|---|
| High | 4 | 9(+5) | Determines the degree |
| defence | | | of mitigation of an |
| | | | opponent's defensive |
| | | | move against a high |
| | | | attack move |
| Mid defence | 4 | 9(+5) | Determines the degree |
| | | | of mitigation of an |
| | | | opponent's defensive |
| | | | move to a mid attack |
| | | | move. |
| Low defence | 4 | 9(+5) | Determines the degree |
| | | | of mitigation of an |
| | | | opponent's defensive |
| | | | move against a low |
| | | | attack move. |
| High | 4 | 9(+5) | Determines the amount |
| counter | | | of damage inflicted on |
| attack | | | an opponent with a |
| | | | successful high |
| | | | counter attack |
| Low counter | 2 | 9(+5) | Determines the amount |
| attack | | | of damage inflicted on |
| | | | an opponent with a |
| | | | successful low counter |
| | | | attack |
| Stamina | 20 | 30(+10) | Determines the amount |
| (energy) | | | of stamina (energy) |
| | | | with which a player |
| | | | will start the game |

Optionally, the “Defend Moves” screen 1100 may additionally comprise a second information field 1120 which, in an embodiment, operates as a ticker tape that carries information relating to, for example, third party products and/or services.

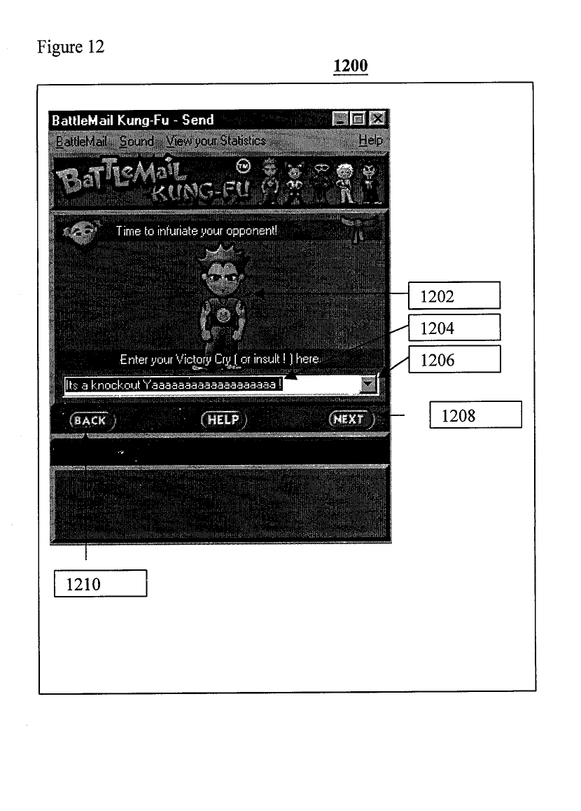

The “Defend Moves” screen 1100 also contains a “Back” button 1122 via which the challenger can return to the “Attack Moves” screen 1000 shown in FIG. 10. The “Defend Moves” screen 1100 comprises a “Next” button 1124 that forwards the user to a “Send” screen 1200 as shown in FIG. 12.

The “Send” screen 1200 displays an image of the selected fighter 1202 and invites the user to enter A Victory Cry in an input field 1204 to be displayed to the opponent in the event of victory. Preferably, a pull-down menu button 1206 is provided which allows the user to select a Victory Cry from a history of previous victory cries.

The “Send” screen 1200 also comprises a “Next” button 1208 in response to actuation of which the console software 104 collates all of the information input by the challenger and stores that information within, for example, a Microsoft Word or text file or some other suitable data file. In a preferred embodiment, as indicated above, the data is stored in a *.BMD file for subsequent transmission to the games server 108. A “Back” button 1210 is provided which returns the user to the previous screen.

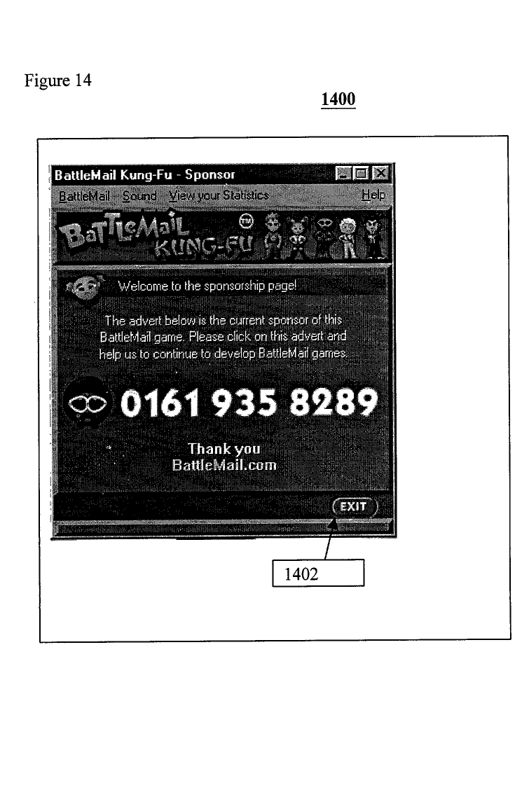

Having collated all information and issued the challenge, a further screen 1300, entitled “Processed”, is displayed to the challenger. The “Processed” screen 1300, outputs an indication that the challenge has been issued to the named opponent. The “Processed” screen 1300 also comprises two buttons, namely “Next” 1302 and “Continue” 1304 that can be used to close the console software 104 console or to issue a further challenge respectively. Selecting the “Next” button causes the console software to be closed. Selecting the “Continue” button 1304 preferably takes the user to a Sponsorship screen 1400 as shown in FIG. 14. The sponsorship page allows a user to navigate to a web-site of a sponsor via an embedded and appropriately located URL (not shown) The sponsorship page comprises an “Exit” button 1402 via which the user can exit the sponsorship page 1400.

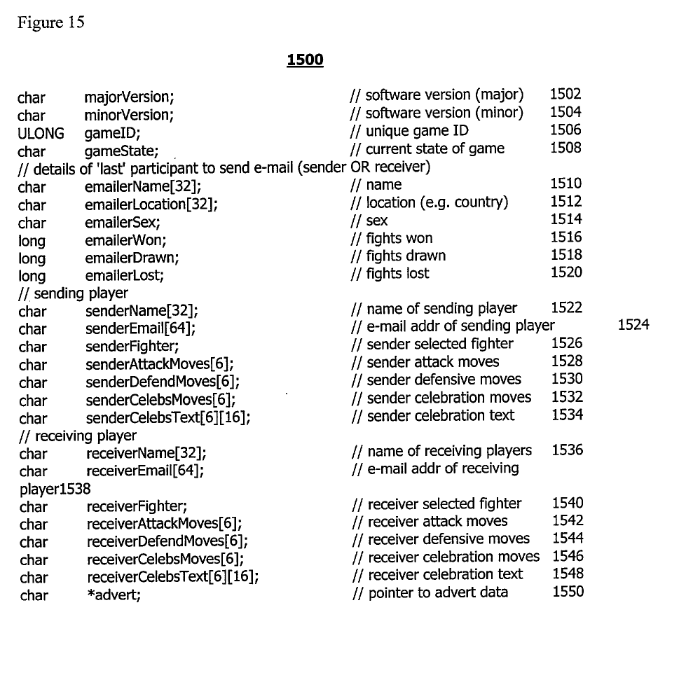

The battle mail console software creates within the Outbox (not shown) of the proprietary email software an email and addresses that email to the remote server, that is, the battle mail server. The created email has as an attachment the data file, *.BMD, containing the challenger's data. The data contained within the attachment is described hereafter with reference to FIG. 15. Referring to FIG. 15 there as shown a data or record structure that is used to collate the data to carry the data contained within the attachment created by the battle mail server and/or the battle mail console software. The first two fields 1502 and 1504 identify the major and minor software versions of an embodiment of the present invention respectively.

An unsigned long integer gameID as used store a unique identifier which identifies the game, such as the fighting game described above, used in an embodiment of the present invention. The gamelD 1506 will vary according to the game used in the embodiment. A character gamestate 1508 is used to identify the current state of a game. A game may have several states which are:

GAMESTATE_REQUESTFROMCONSOLE—reflects the state of a game when the remote serve receives a request for a new challenge;

GAMESTATE_REQUESTPROCESSEDFROMCENTRE—reflects the state of the game when a new incoming challenge has been processed;

GAMESTATE_acceptedfromconsole—reflects the game state when an opponents has accepted and responded to a new challenge;

GAMESTATE_ACCEPTEDPROCESSEDFROMCENTRE—reflects the game state when the remote server has processed the opponents response to the challenge; and

GAMESTATE_DECLINEDFROMCONSOLE—reflects the state of the game when an opponent has declined a charge.

In summary, when a new fight starts (a challenger requests a new challenge) the game state is set to GAMESTATE_REQUESTFROMCONSOLE and the relevant e-mail and data attachment is sent to the remote server for processing. Once processed, the remote server up-dates the game state to GAMESTATE_REQUESTPROCESSEDFROMCENTRE to indicate that the game data is valid and has been processed by the remote server. The opponent receives the game data from the remote server and can either accept of decline the challenge. If the opponent accepts the challenge, the game state is set to GAMESTATE_ACCEPTEDFROMCONSOLE and the relevant e-mail and data attachment is sent back to the remote server. Again, the remote server processes the game data and updates the game state to GAMESTATE_ACCEPTEDPROCESSEDFROMCENTRE to indicate that the data has been processed. Once the data has been processed, the process data is returned to both the original challenger and the opponent to display the animated fight. Alternatively, an opponent may decline a fight in which case the game state is set to GAMESTATE_DECLINEDFROMCONSOLE and the fight does not take place.

The email of the name of the party that has sent an incoming email to the battle mail server of the current attachment is stored in an array of 32 characters entitled emailerName[32] as shown at 1510. The location of the party sending the email is also stored in a 32 character array called emailerLocation[32] as shown at 1512.

The Sex or the gender of the last participant is stored in a single character variable entitled emailerSex as indicated at 1514. The number of victories of the last participant is stored as a long integer in emailerWon as shown in 1516. The number of drawn battles is stored in a long integer as shown in emailerDrawn 1518 and the number of lost battles is stored in emailer lost as shown in 1520.

The details of the party which initiated the challenge or which sent the email containing the attachment are stored in character form in variables 1522 to 1534. The details of the party to receive the next email in the game are stored as characters in variables 1536 to 1550. The name of the sending player stored in senderName 1522. The email address of the sending player is stored in email of senderEmail[64] 1524. The preferred fighter of the sending player is stored in senderFighter 1526. The six attacking moves of the sender are stored in senderAttackMoves[6] 1528. The six defensive moves of a sender are stored in senderDefendMoves[6] 1530. The sender celebratory moves are stored in senderCelebsMoves[6] 1532 and the sender celebratory text is stored as a 2D array in senderCelebText[6][16] 1534. The celebratory moves represent those moves undertaken by a victor in the event of victory in a fight.

The details of the intended recipient of the email are stored in corresponding variables to the above described sender player details. There is also included a character pointer *advert that is used to point to the advertisement data retrieved from The data base server 218. This advert will be displayed to the parties to the battle.

The remote mail server 108, upon receipt of the email bearing the issued challenge, opens the attachment received from the challenger and processes the data therein. The remote server 108 causes an email to be sent to the opponent using the opponent's email address that was entered in the field 804 of FIG. 8.

The opponent will receive an email from the remote mail server that has an attachment containing data. The data includes the name of the challenger together with data which when rendered graphically represents information relating to, for example, at least one third party advertisement.

It will be appreciated that the data can contain multiple advertisements that can be selectively displayed in a time varying manner on a or each screen output to a user.

The attachment has an extension *.BMD. The data collated from a user, that is, the challenger or an opponent, is written to a file on the user's hard drive. Table 3 below shows in general terms the information contained within the attachment. FIG. 15 described above illustrates a record structure that is written to the *.BMD file.

TABLE 3

| Element | Description |
|---|---|
| FILE_INFO_HEADER | Contains information identifying the |
| | file as a BMD file, the version of the |
| | software and whether or not a bit map |
| | is present (at the end of the file) |
| | containing an advertisement image and |
| | containing a corresponding embedded to |
| | the advertisers web-site. |
| REGISTRATION_DATA | Contains information identifying the |
| | user. This information includes the |
| | name, e-mail address, location, |
| | gender, age range and option whereby |
| | the user can select whether or not to |
| | receive future correspondence from |
| | Battle Mail via e-mail. This |
| | information is used to up-date a |
| | centrally held database comprising |
| | information to identify specific |
| | users. |
| FIGHT_INFO | Contains data that is required by the |
| | software, that is, the Battle Mail |
| | console software, to make possible the |
| | running of a game between Battle Mail |
| | users. The data stored identifies the |
| | participants, the selected game |
| | characters, their skill levels, |
| | selected attack moves, etc. |
| Advertisement | An advertising image (bit map) to be |
| Bitmap | displayed onthe Battle Mail console |
| | during use of the software as |
| | identified using an appropriate |
| | pointer. |

The opponent having opened the email proceeds to open the attachment in the conventional manner. When the battle mail console software is initially installed, an association is created between a file having a *.BMD extension and the battle mail console software such that when a user double clicks or attempts to open the battle mail data file, the battle mail console software is launched automatically and the data contained in the attachment is processed automatically.

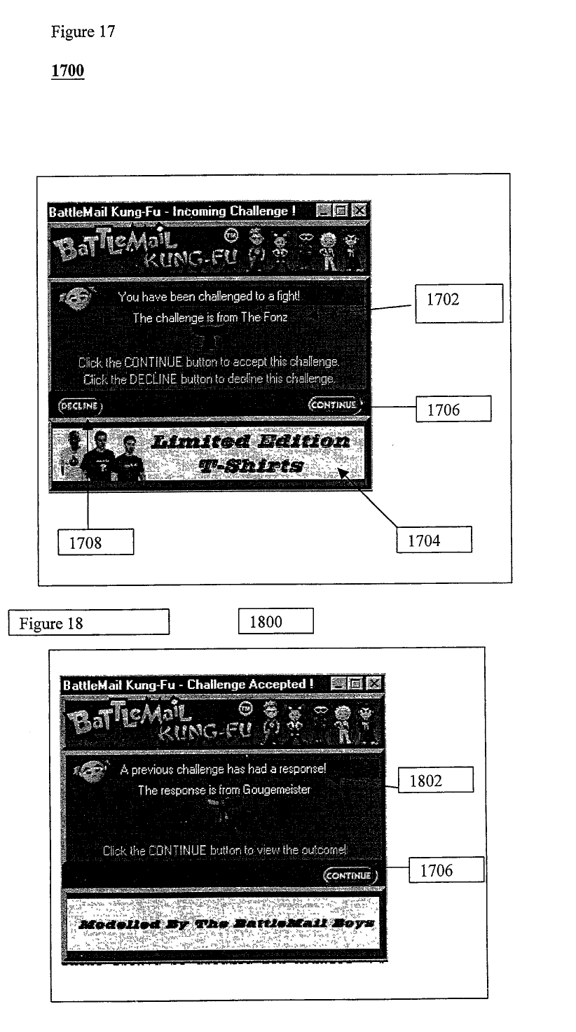

The battle mail console software causes there to be displayed an “Incoming challenge!” screen 1700 as shown in FIG. 17. The “Incoming Challenge!” screen 1700 comprises an announcement that a challenge has been issued by a challenger whose name is displayed in a message “You have been challenged to a fight! The challenge is from The Fonz” 1702. The “Incoming Challenge!” screen 1700 comprises an “information display” field 1704 which is used to display data extracted from the email or the title of the current game. The extracted data represents for example, an advertisement. The challenge is accepted by pressing the “Continue” button 1706 which leads the prospective opponent through a sequence of screen equivalent to the screens described above in relation to FIGS. 6 to 12 via which appropriate opponent information is collated and via which corresponding opponent attacking move, defending moves and victory cry are entered.

The console software 116 creates an outgoing email in the Outbox of the proprietary email software 114. The outgoing email has as an attachment a file containing the data input by the opponent. The created outgoing email is addressed to a remote server, that is, the mail server 108 for subsequent processing.

The remote server upon receiving the opponent's email extracts the data contained within the attachment and processes the data representing the challenger's attacking and defensive moves and the opponent's attacking and defensive moves to generate data representing graphically the attacking and defensive moves of the selected fighters of the challenger and opponent and the effect of those moves on the respective fighters. The remote mail server determines by processing the attacking and defensive moves of the challenger and opponent the winner of the fight.

A player wins a fight in one of either of two ways. Firstly, with each blow, when balanced against a defensive move in appropriate circumstances, the energy of the character receiving the blow is decreased according to the net effect of the value of that blow less the value of a corresponding defensive move. When the character's energy level reaches zero, that character is deemed to have been knocked out. Knocking a character out results in an automatic win. Secondly, if both characters are still standing at the end of a fight, the character having the most remaining energy wins.

Both characters commence a fight with 20 energy units. Every time a character receives a blow, 4 energy units are deducted, or 2 energy units in the case of a counter attack, from the remaining energy. Thus, in a fight between 2 new players, without any adjustment to their score, successfully hitting an opponent 5 times would be sufficient for a knock out.

Preferably, in an embodiment, the effect of a high attack move is totally negated by a corresponding high defensive move. Similarly for all other offensive moves and corresponding defensive moves.

The data processing system 108 having processed the data contained within the challenger's email and the opponents email, as indicated above, transmits a further email addressed to each of the challenger and the opponent. That further email is stored within the inbox of the proprietary email software until it is invoked by the user. Upon invocation, a screen 1800 as shown in FIG. 18 is displayed which bears the message “A previous challenge has had a response! The response is from Gougemeister” 1802. The animated fight sequence is invoked by selecting the “Continue” button 1804.

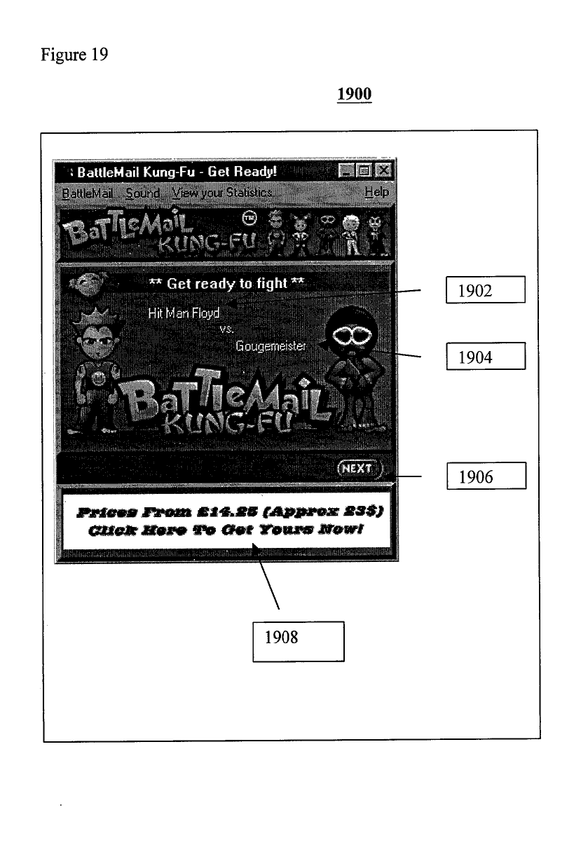

Invoking the “Continue button” 1804 causes a “Get Ready!” screen 1900 to be displayed as shown in FIG. 19. The “Get Ready!” screen 1900 displays the characters and names 1902 and 1904 of the participants. The “Get Ready!” screen comprises a “Next” button 1906 via which display of the animated fight sequence is commenced. Preferably, an information display field 1908 is also displayed.

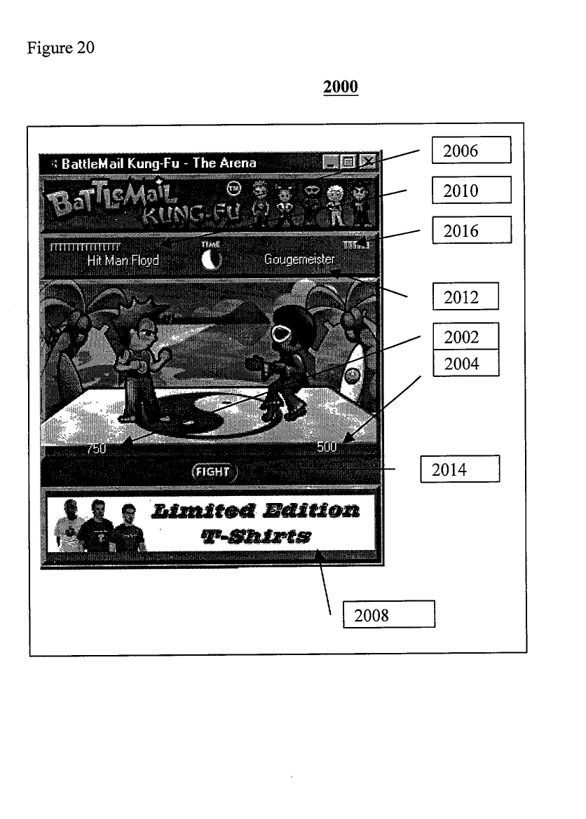

Selecting the “Continue” button 1906 takes the user to a screen 2000 entitled “THE ARENA” as shown in FIG. 20 via which the fight sequence will be shown. It can be appreciated that each character has associated therewith a score 2002 and 2004. Preferably, the score determines the current performance level of a character. The score is also used to rank the character in a league table held centrally at the battle mail server. The points making up the score are acquired as follows:

standard hit—250 points,

counter attack—125 points,

winning a fight—1000 points plus 200×level difference of opponent,

fighting a new opponent—500, and

knocking out an opponent without taking a hit—5000.

As a character's score increases so, does the “experience level” of that character. Table three below recognises this experience in a manner analogous to Kung Fu by changing the colour of the belt of the character. Table 4 below shows the belt colour of a character and the score needed to achieve a change in belt colour.

TABLE 4

| Belt | Score Needed |
|---|---|
| White | 0 |
| Yellow | 10,000 |
| Green | 25,000 |
| Blue | 75,000 |
| Brown | 150,000 |
| Black | 250,000 |
| Master | 500,000 |

As the user progresses to each experience level several points, such as 3 points, are awarded for distribution to that characters fighting capability as shown in Figure R and described below.

The victor of a fight is awarded a number of points representative of the comprehensiveness of the victory. The remote mail server creates an outgoing email that is addressed to both the challenger and the opponent. The outgoing email has an attachment containing data representing the animation of the fight or data from which such animation can be derived by the battle mail console software. The animation depicts the attacking and defensive moves of both the challenger and the opponent. The data also contains an indication of the victor and the points attributed to the victor.

Referring back to the screen entitled “The Arean” 2000 it can be appreciated that the screen 2000 comprises “information” fields 2006 and 2008, “challenger and opponent identification” fields K06 and K08, “challenger and opponent energy level” indicator bars 2010 and 2012, a “FIGHT” button 2014, a graphical representation of the data generated by the remote mail server which can be displayed upon a display (not shown) to show the fight. Preferably, each character also has an associated “health” bar such as, for example, the “health” bar 2016 for the character “Gougemeister”. The “health” bar represents graphically the current state of health of the associated character. If the health bar status diminishes to zero, the character is deemed to have been knocked out.

Optionally, “The Arena” screen 2000 may further comprise display controls such as, for example, comprising a “play” button, a “stop” button and other buttons which be, for example, fast forward or rewind or slow motion forward or backwards buttons to allow the display of the fight sequence to be controlled.

The graphical images representing the data sent by the data processing system 108 causes the fight to be animated by the user selecting the “FIGHT” button 2014.

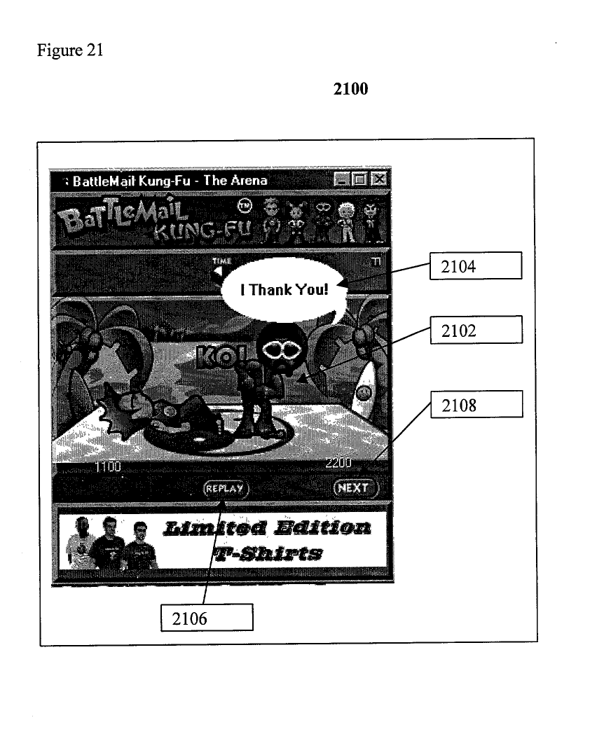

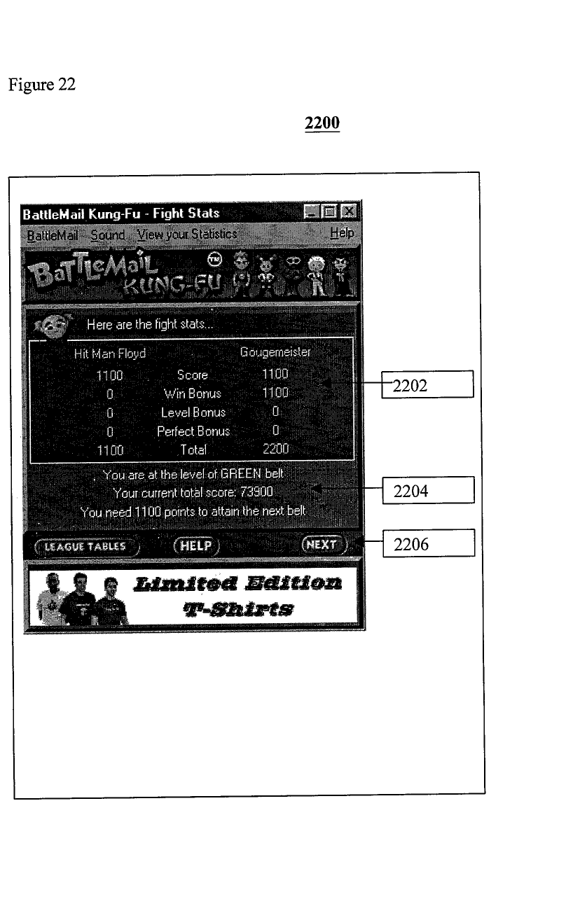

Referring to FIG. 21 there is shown a further arena screen 2100 which shows the victory celebration of one character 2102 together with an indication of the victory message 2104. Also provided is a replay button 2106 that can be used to output the animated fight to replay the animated fight sequence. A “Next” button 2108 is provided which allows the user to progress to the “fight stats” screen 2200 as shown in FIG. 22.

The “fights stats” screen 2200 contains an indication 2202 of the points awarded to or held by each of the participants of the fight. An information field 2204 is provided which contains an indication of the current score and ranking of either the opponent or challenger as appropriate and an indication of the number of points required to reach the next belt. It can be appreciated that the information field 2204 shows the challenger or opponent to be a green belt and that 1100 are required to reach the next belt. The “fight stats” screen 2200 also comprises a “Next” button 2206 which takes the opponent or challenger to the next screen.

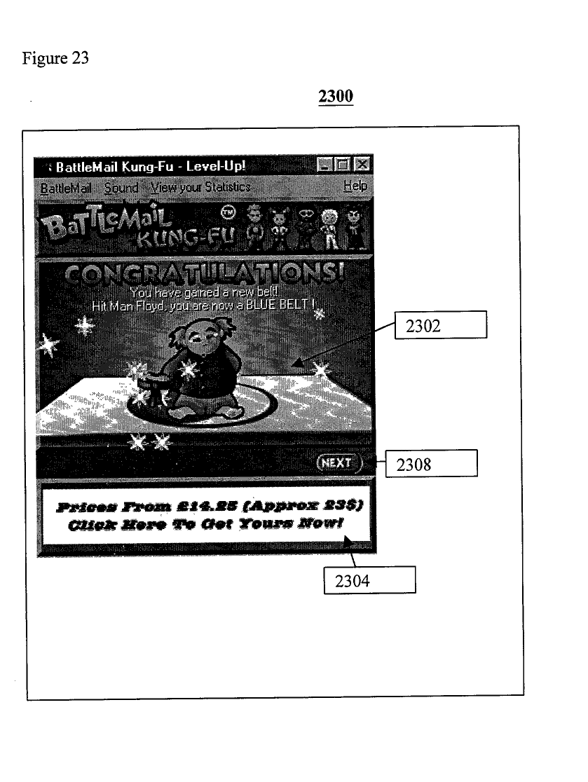

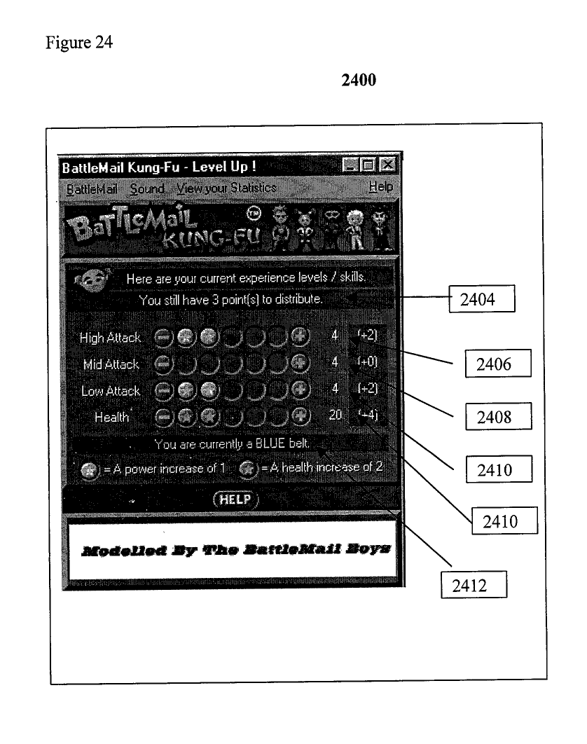

The next screen depends upon the result of the fight, the points and the points accumulated. If sufficient points have been accumulated to allow the opponent or challenger to gain the next belt a “level-up!” screen 2300 as shown in FIG. 23 is output to the challenger or opponent as appropriate. The “level-up!” screen 2300 displays a congratulation message in a corresponding display field 2302. Also provided is an information field 2304 that can be used to output information such as, for example, advertisements. A “next” button 2308 is provided to carry the challenger or opponent to a second “Level up!” screen 2400 as shown in FIG. 24 the second “Level up!” screen 2400 is used to distribute any points associated with the challenger or opponent being promoted to the next belt.

A “Level Up!” screen 2400 is displayed as shown in FIG. 24. The “Level Up!” screen 2400 is used to improve the fighting characteristics of the challenger's or opponent's character according to the winner of the fight. The “Level Up!” screen 2400 comprises an information display field 2402, a “points remaining” field 2404, a “High Attack” power indicator 2406, a “Mid Attack” power indicator 2408, a “Low Attack” power indicator 2410 and a “Health” indicator 2412 The “Level up!” screen 2400 comprises for each of the above indicators corresponding “plus” and “minus” buttons. These “plus” and “minus” buttons are used to distribute or redistribute the current points of a character and to distribute any points awarded as a consequence of victory in the most recent battle or an improvement in experience level. For example, assume that the “High Attack” field 2406 contains a value of 4 and that 3 points have been awarded as a consequence of victory in the most recent battle. The 3 points may be all allocated to the “High Attack” of the character by depressing the corresponding “plus” button L03 so that the “High Attack” field contains the value 7. This action will change the “High Attack” attributes of the selected character. In effect, the greater the “High Attack” value, the greater the impact of such a “High Attack” will have or the great a defensive character move will have to be to counter that high attach. According to the adverse impact that such a “High Attack” will have on a respective future opponent. The screen 2400 also contains an indication of the new rank of the competitor as can be seen from information field 2412. Once the awarded points have been distributed the user is returned to the “Welcome!” screen 500 as shown in FIG. 5.

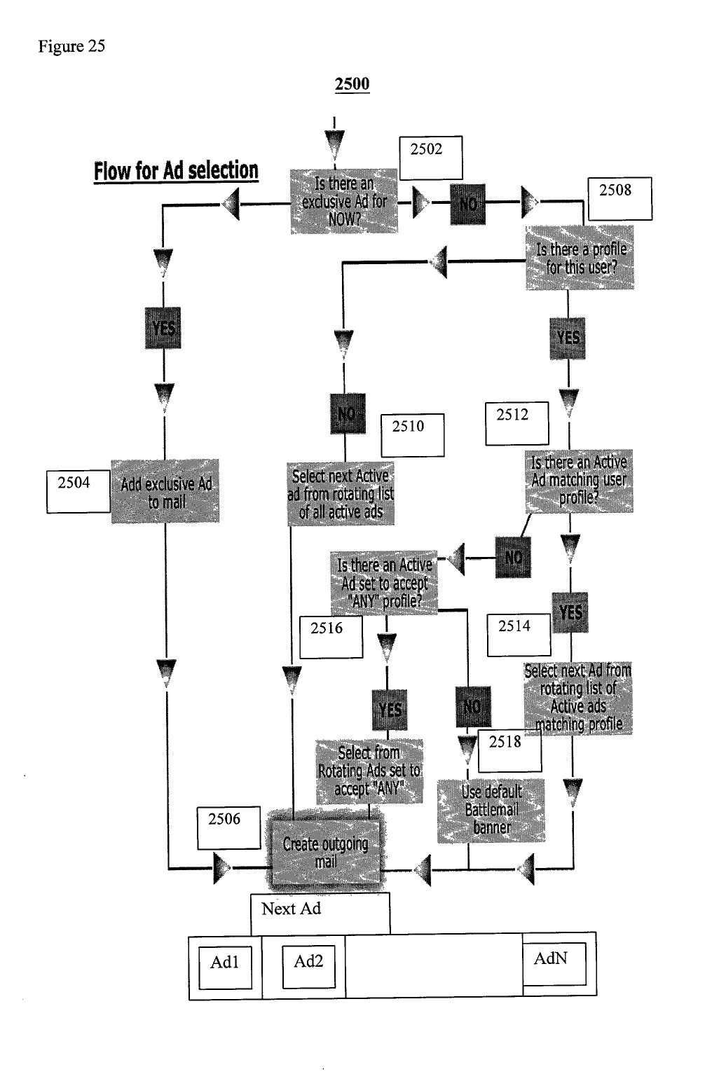

Referring to FIG. 25 there is as shown a decision flow chart 2500 which is performed by the game servers 210 and 212 and The data base server 218 in determining or selecting information for use with an outgoing email. It will be appreciated that although the embodiment shown in FIG. 35 is used to select advertising information, the present invention can be used to retrieve any type of information for output to the user. At step 2502 a determination is made as to whether there is an exclusive advertisement for a current time slot or time period. If there is such an exclusive advertisement for the current time period, information reflecting that exclusive advertisement is retrieved at step 2504 from The data base server and included in an attachment for an outgoing email at step 2506. If there is not an exclusive advertisement for the current time period control is transferred to step 2508 where a determination is made as to whether or not there is stored within The data base server 218 a profile for a current user associated with an incoming email. If there does not exist a profile for the current user, control is passed to step 40 where an advertisement is selected for incorporation into the attachment of the outgoing email created at step 2506.

It can be appreciated that there are many ways in which the next advertisement can be selected. For example, there may be list of active advertisement that have been selected from a plurality of advertisements for use or inclusion in outgoing emails. Alternatively, the next advertisement to be incorporated into an outgoing email may be that advertisement which is next in a circular queue. The pointer in that circular queue can be changed according to any satisfied criteria such as the current advertisement having been displayed a predeterminable number of times.

If the determination made at step 2508 is such that a user profile has been created for the sender of the incoming email or for the intended recipient of an outgoing email, control is transferred is to step 2512 where a determination is made as to whether or not there is an active advertisement, that is, an advertisement in a set of advertisements which has been selected from a plurality or from a the total number of advertisements, which matches the user profile. If there is an advertisement which matches the user profile within the active advertisements, control is passed to step 2514 where the next advertisement, or where an appropriate advertisement, is selected from the possible qualifying advertisements, that is, those advertisements matching the user profile, for incorporation into an outgoing email which is created at step 2506.

If the determination made at step 2512 is such that there is not an active advertisement which matches the current user profile control is transferred to step 2516 where a determination is made as to whether or not there is an active advertisement set comprising at least one advert that is suitable for the characteristics of any user profile. If there is no such advertisement set, control is transferred to step 2518 where a default advertisement, such as the battle mail banner, is incorporated into the attachment of the outgoing email created in step 2506. However, if there is such an active set, an advertisement is selected from that active set and incorporated into the attachment of an outgoing email which is created at 2506.

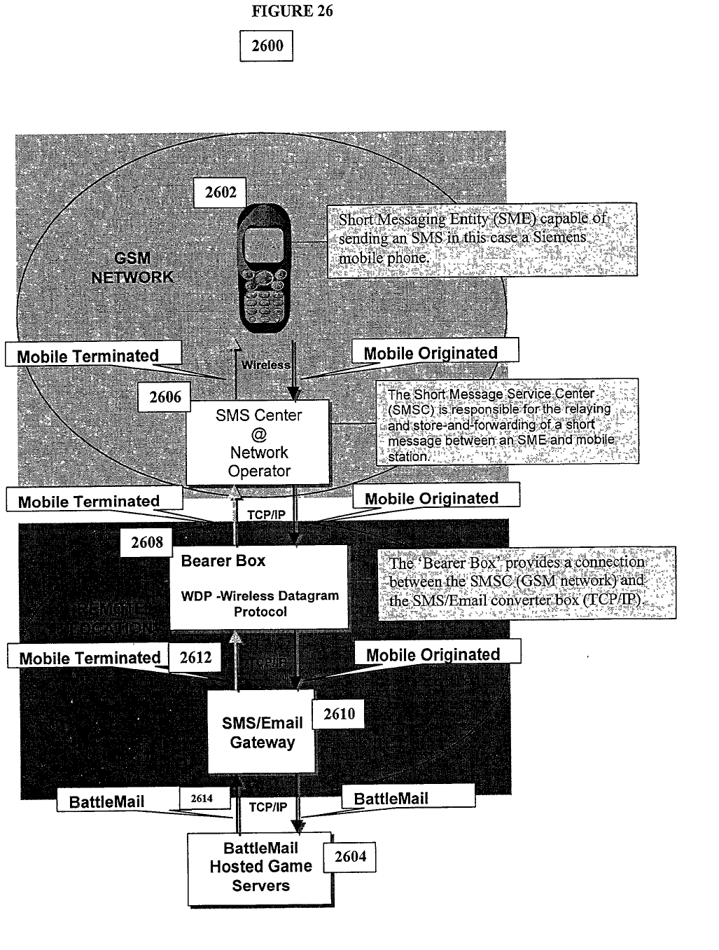

Referring to FIG. 26 there is shown an overall architecture 2600 for implementing an embodiment of the present invention which uses a short messaging entity (SME) 2602 to exchange data with a data processing system 2604. The remote data processing system 2604 is arranged to process data received from at least two such SME devices and to transmit the results of the processing to two SME devices. The remainder of the preferred embodiments will be described with reference to the remote data processing system being a games server.

The architecture 2600 comprises a short messaging entity 2602 capable of sending an SMS message to a short message service centre (SMSC) 2606 which forms part of, for example, a GSM network. The short message service centre 2606 is arranged to relay, that is, to store-and-forward, a short message between the short messaging entity 2602 and the SMS centre 2606.

The short messaging entity in a preferred embodiment is a mobile communication device such as, for example, a mobile telephone. The remainder of the preferred embodiments will be described with reference to the SME being a mobile telephone.

The SMS centre 2606 is connected, via a TCP/IP link, to a bearer box 2608. The bearer box 2608 provides a connection between the SMSC (GSM network) and an SMS/email gateway 2610, again, via an appropriate TCP/IP connection 2612. A further TCP/IP connection 2614 is used to connect the SMS/email gateway 2610 to the remote server 2604, that is, to at least one games server. Preferred embodiments utilize a plurality of SMS/Email servers to form the SMS/email gateway 2610 together with suitable load balancing. Similarly, the remote data processing system preferably comprises a plurality of servers having suitably load-balancing to process incoming messages bearing data generated by mobile telephones.

A short message issued by the mobile phone comprises data generated by console software executing on the mobile phone. The console software is distinct from the conventional operational software that is used to provide conventional the voice and data services of a mobile phone. Preferred embodiments of the present invention comprise data representing game play data. The preferred embodiments will be described hereafter with reference to such game play data.

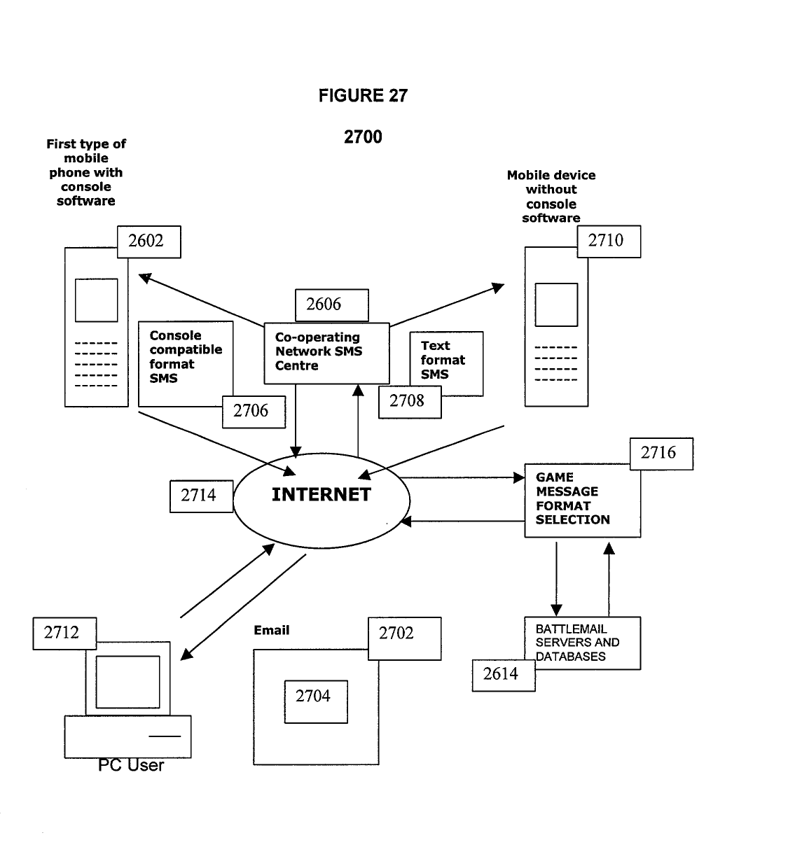

Referring to FIG. 27 there is shown an architecture 2700 for an embodiment of the present invention which allows or supports cross-platform integration, that is, exchanges between heterogeneous platforms each of which are capable of running a corresponding console that is capable of interpreting the data contained within those messages. It will be appreciated that the same data produced by the games server will produce substantially the same effect when processed by the console software notwithstanding the platform on which the console software is executing.

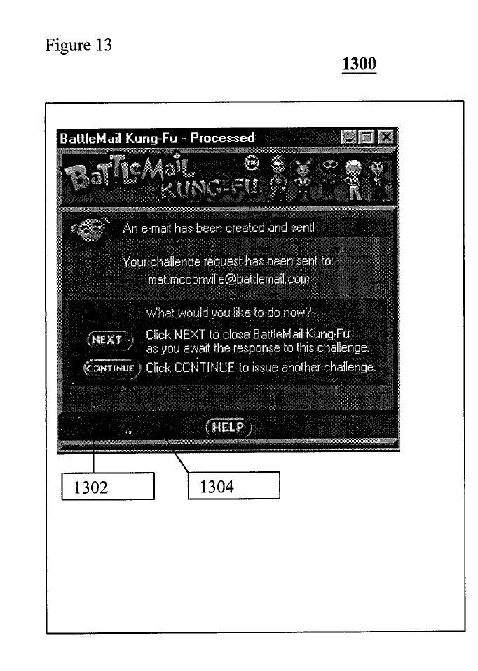

The data is carried within either an email 2702 having a corresponding email attachment 2704, in a manner substantially as described above, or an SMS format message such as SMS messages 2706 and 2708. It can be appreciated from the architecture 2700 shown in FIG. 27 that there are shown 3 platforms upon which embodiments of the present invention maybe implemented. The first platform, is, for example, a mobile phone 2602, the second platform is a text only mobile phone 2710 and the third platform is a PC 2712. The PC based embodiments of the present invention have been described above in relation to FIGS. 1 to 25.

Still referring to FIG. 27, it can be appreciated that the mobile phones 2602 and 2710 exchange corresponding SMS messages 2706 and 2708 respectively with the SMS centre 2606. The SMS centre 2606 forwards received text messages via a communication network, such as, for example, the Internet 2714, to the remote data processing system 2604. In a preferred embodiment, a game message and format selection apparatus 2716 is provided which converts the received messages from the remote devices, that is, the mobile phone 2602, the other mobile phone 2710 and the PC 2712, to a common format suitable for processing by the remote data processing system 2604. In effect, the data contained within the attachment 2704 of the email 2702 and data contained within either of the two SMS messages 2706 and 2708 are extracted therefrom and presented to the remote data processing system 2604 in a common format.

Once converted into a suitable format, the game play data is processed and the results of the data processing are determined and are routed back to the originating communication devices 2602, 2710 and 2712 via the message format selection apparatus 2716. The message format selection apparatus 2716 converts the game play data, and in particular the results of the data processing, received from the games server 2604 into appropriate message formats for transmission to the remote devices 2602, 2710 and 2712 via the Internet 2714, using email 2702 and suitable attachment 2704, and an SMS centre 2606 together with corresponding SMS format message 2706 and 2708. The messages generated by the message format selection apparatus 2716 routes the messages together with the game play data payload to the originating devices for subsequent processing.

Upon receipt of a message, the remote devices 2602, 2710 or 2712 extracts the game play data and processes that data using corresponding console software. In preferred embodiments, the corresponding console software, described hereafter in further details, generates images showing the game play data.

Referring to FIG. 28 there is shown schematically the functional elements of a mobile communication device 2800, such as a mobile phone 2602, according to an preferred embodiment. The mobile telephone comprises a display 2802 for outputting graphical data generated by console software 2804 which is stored in RAM 2806 and is executed by a microprocessor 2808. It will be appreciated that generally the microprocessor 2808, in conjunction with the operational software, also provides standard telephony functions as are commonly found within the vast majority of mobile communication devices.

It will be appreciated by one skilled in the art that the console software and the operational software are functionally distinct. The operational software 2826 provides the known telephony functions such as, for example, dialling, audio codec compression and decompression, text output, text input, address book management and various forms of dialling. In contrast, the console software is arrange to interpret data send by a games server 2604 to control the display of images on the screen 2802 of the mobile phone 2800 as well as to generate data input by a user for transmission to the data processing system.

Preferably, the console software 2804 can also generate audio data, preferably conforming to a GSM audio codec standard, for processing by an audio codec 2810 to be output via a corresponding speaker 2812. A microphone 2814 is also provided to receive analogue audio information. The analogue audio information is converted via the audio codec 2810 into voice data for subsequent transmission by the telephone 2816 using corresponding packaging software and RF apparatus (not shown).

In a preferred embodiment, the messaging system 2816 is a text messaging system via which a text message 2818 comprising data 2820 generated by the console software 2804 can be transmitted to the SMS centre 2606. The messaging system 2806 can also receive messages, such as received messages 2822, from the SMS centre that also contain data 2824 to be processed by the console software 2804 to produce graphical outputs, preferably in the form of animation, on the display 2802 and audible outputs via the audio codec 2810 and corresponding speaker 2812. Therefore, it can be appreciated that two types of message can be received by the mobile phone. The first type of message is a conventional SMS text message which is processed by the messaging system 2816 in the conventional manner, that is, the received SMS text message is stored in the conventional SMS in-box (not shown) of the mobile phone. The second type of SMS message is a message comprising a data payload for or generated by the console software. The second type of message, when generated by the console software, is placed in a corresponding outbox for transmission to the remote data centre. Preferably, the outbox for the console software and the outbox for the conventional SMS messages are one and the same. Alternatively, separate outboxes can be provided. Once the messaging system has identified a message as being a second type of message, that second type of message is placed in an inbox that is accessible by the console software.

It will be appreciated that the inbox 2832 can be provided as a separate inbox from that conventionally used for SMS messages. The separation may be physical or logical, that is, respective physical areas of RAM may be provided or, preferably, a common area of RAM is used to store both types of messages. The types of the messages can be determined from respective message identifiers described hereafter in greater detail.

Upon initialisation of the mobile phone, the console software 2804 and the conventional mobile phone software 2826 are loaded from an EROM 2828 into the RAM 2806. The mobile phone also comprises a keyboard or other form of input device for operating or invoking the conventional functions of the mobile phone and for controlling or generating inputs for the console software 2804.

In a preferred embodiment when an SMS message which carries a data payload for the console software 2804 is received by the messaging system 2816 of the mobile telephone 2800 the message is routed to the console software 2804 for further processing via the inbox 2832.

In a preferred embodiment, the total length of received or transmitted message, that is a conventional SMS message or a data message for or generated by the console software, may contain 140 bytes of 8 bit data. The structure of an SMS comprises at least (a) an SMS Header (b) a console specific header and (c) a data payload. The SMS header comprises at least an identifier by which the messaging system 2816 can identify the message as either a conventional text message or a data message for processing by the console software 2804. The console specific header comprises data relating to the structure of the data payload, that is, the message type as well as, preferably, data integrity information such as, for example, CRC information for the message.

A header is used for both outgoing and incoming text messages or, with an appropriate change to the header, for outgoing and incoming messages bearing console 2804 generated games data as a payload. The messaging system 2816 recognises a received SMS message as being a conventional SMS message by the absence of any data showing the SMS message to be a type other than a conventional message. Alternatively, the type of message is determined from the presence or absence of “BMD” in a Mimetype field of the message. Therefore, if the Mimetype field is empty, the messaging system interprets the received SMS message as a conventional message. If the Mimetype message contains “BMD” the messaging system 2816 interprets the message as being intended for the console software. The messaging system 2816 comprises a router (not shown) for routing the received messages according to their determined Mimetype.

In a preferred embodiment, a data message intended for the console software has a data payload, as mentioned above. The data payload may take be one of the following data types:

1. BM-Header,

2. BM-Action,

3. BM-String,

4. BM-GID,

5. BM-Player info, and

6. BM-Game result info

The individual headers will be described hereafter in greater detail.

The structure of the BM-header is comprises at least two parts. Firstly, a field which identifies the type of message, that is, the structure of the data contained within the payload, and, preferably, data integrity information which can be used to check the data integrity of the received message. The message type preferably takes one of a number of possible values which are defined below in table 5.

TABLE 5

| Value | Description |
|---|---|
| 1 | Game Challenge sent |
| 2 | Game Acceptance |
| 3 | Game Challenge received |
| 4 | Game result received |
| 5 | Reserved |
| 6 | Reserved |

A message type of 1 indicates that the message is an outgoing message from the mobile phone that has been generated from the console software. A message type of 2 indicates that the message is again an outgoing message from the mobile phone that conveys data generated by the console software in response to receipt of a challenge received message. A message type of 3 indicates that the message carries data generated by the console software of another platform to which a response is required. A message type of 4 indicates that the message bears data which has been generated by the data processing system 2604 in response to processing data contained within messages from at least two third parties. Optionally, the message type may take other values as indicated in TABLE X, which may relate to other applications.

A send a challenge message, that is, a type 1 message, a structure as shown below in table 6.

TABLE 6

| Type 1 | Meaning/Value |
|---|---|
| BM-Header | — |
| BM-Action | Challenger |
| BM-String | Challenger Victory |
| | cry |
| BM-String | Recipient Identifier |
| BM-String | Sender Alias |
| BM-String | Sender E-Mail |

The BM-header is as described above. The header BM-Action is described hereafter and is used to contain data generated by the console software in response to user inputs. In a preferred embodiment, the user inputs relate to a game, such as a combat game described hereafter, which the moves to be undertaken by a selected character. The remaining field, that is, the BM-string fields, are used to contain data relating to characters. As can be appreciated from table 6, the first BM-String field comprises data representing a Victory Cry to be output to an opponent in the event of a successful combat. The Recipient identifier relates to an identifier of a third party to whom a challenge should be issued and the remaining two BM-String fields comprise data relating to characters via which the challenger can be identified and the email address of the challenger.

The second message type, Message Type 2, which is for issuing an acceptance of a game, Game Acceptance, has a structure as shown below in table 7.

TABLE 7

| Type 2 | Meaning/Value |
|---|---|
| BM-Header | — |
| BM-Action | Local Player action |
| | info |
| BM-GID | Game ID |
| BM-String | Victory cry of local |
| | player |
| BM-String | Recipient ID |
| BM-String | Sender Alias |
| BM-String | Sender E-Mail |

It will be appreciated from table 7 that the data reflects the data described above in relation to table 6 subject to the modification that the data relates to an opponent rather than to a challenger.

The third message type, Message Type 3, which relates to the receipt of data from the remote data processing system 2604 representing a challenge, has a structure as shown in table 8.

TABLE 8

| Type 3 | Meaning/Value |
|---|---|
| BM-Header | — |
| BM-GID | Game ID |
| BM-Playerinfo | Recipients Player info |
| BM-String | Challenger Character |
| | Selected |
| BM-String | Challenger Alias |

The fields of the third type of message are BM-GID which can be used to identify the console software to be launched in the event of receipt of a type 3 message or an indication of the software, such as the console software 2804, which should be used to process the data contained within the message. The field BM-playerinfo is preferably provided to convey information relating to a user of the mobile phone 2602. Such data, in a preferred embodiment, comprises data relating to past combats by the user using a particular selected character. The first BM-string field contains an indication of the character selected by the user and the second BM-string field contains data representing an alias for the user to be used in exchanges with opponents and the data processing system 2604.

The fourth message type, Message Type 4, which is a message bearing the results of the data processing performed by the games server 2604, is shown below in TABLE 9.

TALBLE 9

| Type | Meaning/Value |
|---|---|
| BM-Header | — |
| BM-Action | Challenger Action |
| BM-Action | Opponent Action |
| BM-Playerinfo | Recipient Playerinfo |
| BM- | Game Result |
| GameResultInfo | |
| BM-String | Challenger Alias |
| BM-String | Opponent Alias |
| BM-String | Winner's Victory Cry |

The fourth message type is used to convey to the console software data representing the results of the processing by the remote data processing system of the data provided in the send challenge and accept challenge messages, that is, the data contained within the first and second types of message. It can be appreciated that the above described BM-Action data for both the challenger and the opponent are contained within the fourth type of message. The BM-playerinfo information is also included within this message as is the Challenger's alias and the opponents alias together with the data representing the Victory Cry of the challenger or opponent, according to the result of the data processing. The field BM-GameResultInfo contains data presenting the victor in a challenge or an indication that the combat or exchange resulted in a draw. In a preferred embodiment, the various points, such as experience points, health points etc awarded to or deducted from the statistics associated with a selected character.

As indicated above the fifth and sixth message types are reserved for future expansion.

The header BM-Action contains data relating to the inputs made by the user of the console software. In a preferred embodiment, the inputs relates to attacking and defending moves to be undertaken by a selected character in a combat with a selected character of an opponent. In the preferred embodiments described below with reference to FIGS. 3 to 30, six attacking moves directed at high, middle and lower portions of an opponent and six defensive moves aimed at protecting high, middle and low portions of the a selected character. Preferably, the BM-action header also contains an indication of the selected character.

It can be appreciated that the character selected at step 3104 of the flowchart 3100 shown in FIG. 31 is identified within the BM-Action header. In a preferred embodiment the console type, that is, a version of the console software to be used in interpreting the data payload, is indicated within the BM-Action header. It will be appreciated that the console software type may represent, for example, different types of combat or competitive games or different software to be invoked or used in interpreting data contained within the payload of a received message. In a preferred embodiment the console type identifies a corresponding game, possibly selected from a plurality of console types.

The header BM-string is used to describe data that relates to strings. In an embodiment, each character of a string is represented using 7 bit encoded data.

The BM-GID header is used to contain data that allows the remote game server 2604 to track and match messages from the mobile telephones of participants to a challenge so that the data relating to a challenge and an acceptance of a challenge can be matched at and processed by the remote server. In a preferred embodiment, an issued challenge, that is, a type 1 message, is assigned a unique identifier upon receipt of a challenge. The unique identifier is transmitted to the opponent identified in the challenge by the game server 2604 in a type 3 message. The console software, upon accepting a challenge and issuing a type 2 message in response to appropriate inputs from the user, includes within that type 2 message the unique identifier or at least data from which is can be derived. The inclusion of that unique identifier allows the challenge acceptance message of the opponent to be matched to the issue challenge within the games server 2604.

As indicated above, the message . type, which identifies the corresponding message structure, is held within the BM-header and may take a value of 1 to 4. The value for the message type is used by the messaging system 316 to identify the corresponding message structure of the SMS message payload.

Upon receipt of a message, the message in system 316 determines whether or not that message is a conventional SMS message or a message that should be directed to the console software. If the determination is such that the received message is a conventional SMS message, that message is processed in the usual manner. However, if the determination is such that the receive message is such that it is directed to or should be processed by the console software, as identified by the BM-Identifier header, the message is stored within an inbox 2832 to allow the console software 2804, via the processor 2808, to access that message and process the data contained therein. In a preferred embodiment, the inbox associated with the console software is implemented using non-volatile storage such as an EPROM. It can be appreciated from FIG. 28 that the ROM/EPROM 2828 comprises a permanent storage ROM section for the console software and the operational software as well as erasable section for storing incoming messages and other data.

Therefore it will be appreciated that the mobile communication device comprises, in preferred embodiments, at least 2 inboxes. The first inbox is a conventional SMS message inbox and the second inbox is used to store data to be processed by the console software 2804 resident or running on the mobile communication device.

In operation, the messaging system 2816 of the communication device upon identifying the incoming message as being a data message for the console software forwards message to console inbox 2832 for later processing by the console software. The console software 2804 reads the message stored in the inbox 2832 and locates within the received message the data which identifies the message structure, that is, the message type to allow the data payload to be interpreted. As will be appreciated from the above described message types, the payload can vary significantly. The use of the data contained within the payload is as described above in relation to the various tables.

When a user, using the keypad or input device 2830, selects a character and appropriate offensive and defensive moves, the console creates in the outbox 2833 a message for transmission via the message system 2816, such as, for example, message 2822, which comprises console generated data 2824 as a payload. The outgoing messages from the mobile telephone are transmitted in the conventional manner to the SMS centre 2606 which forwards the message, via the bearer box 2608 and SMS/email gateway 2610 to one of at least two mail servers where the message is forwarded to the game server 2604 for processing.

It will be appreciated, upon receipt of either game results from the server 2604 or upon receipt of a challenge from the server 2604, that the received message, once identified as being a console software message, is again placed in the inbox 2832 for processing in due course by the console software 2804.

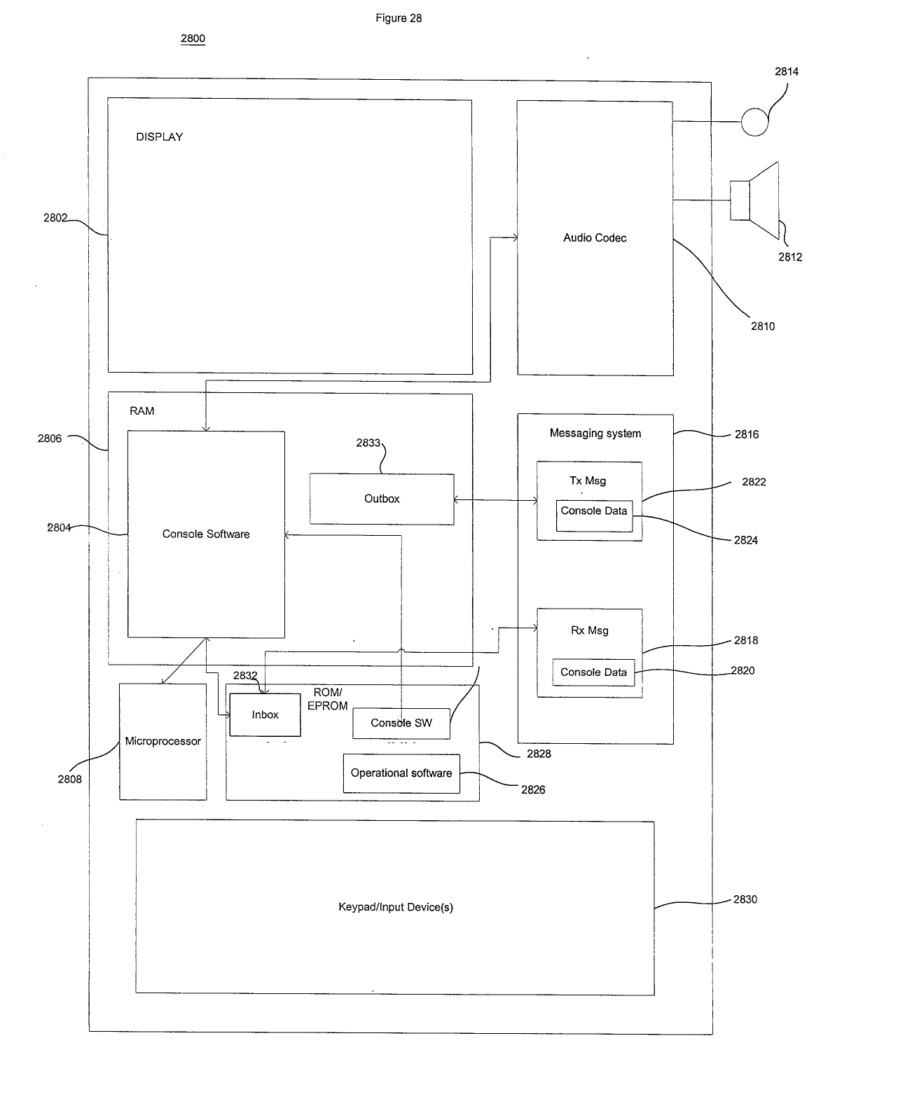

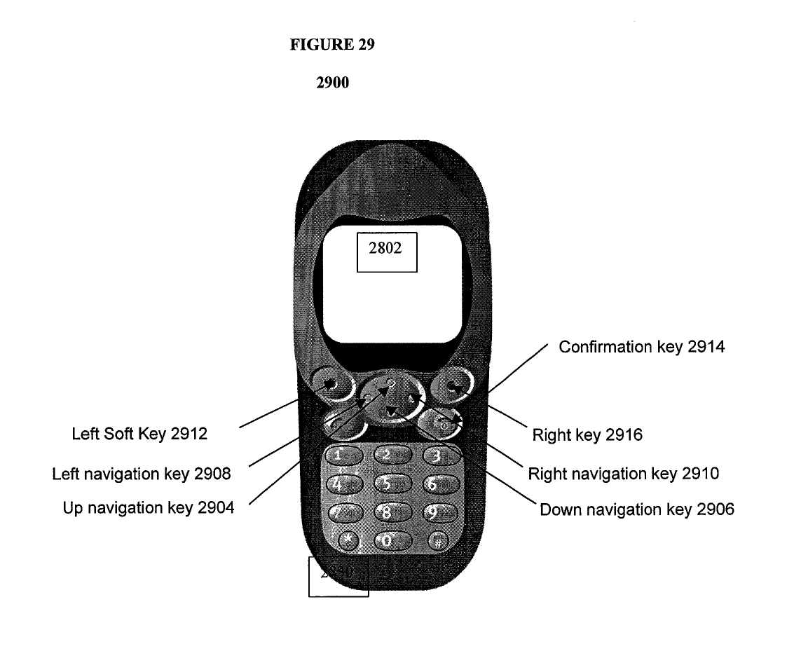

Referring to FIG. 29 there is shown a mobile communication device, at least the external appearance of a mobile communication device, as described above in relation to FIG. 28. It can be seen that the device 2900 comprises a display 2802 and a keypad or a number of input device 2830. The mobile telephone comprises a number of input keys or input devices which support user navigation about the display and user interaction with the console software 2804. Preferably, a set of keys are provided which are known as the up key 2904, down key 2906, left key 2908 and right key 2910. Additionally, there is preferably provided right 2912 and left 2914 keys for progressing to a following screen or returning to a previous screen and a confirmation key 2916 via which data input or selections can be confirmed.

### ISSUING A CHALLENGE

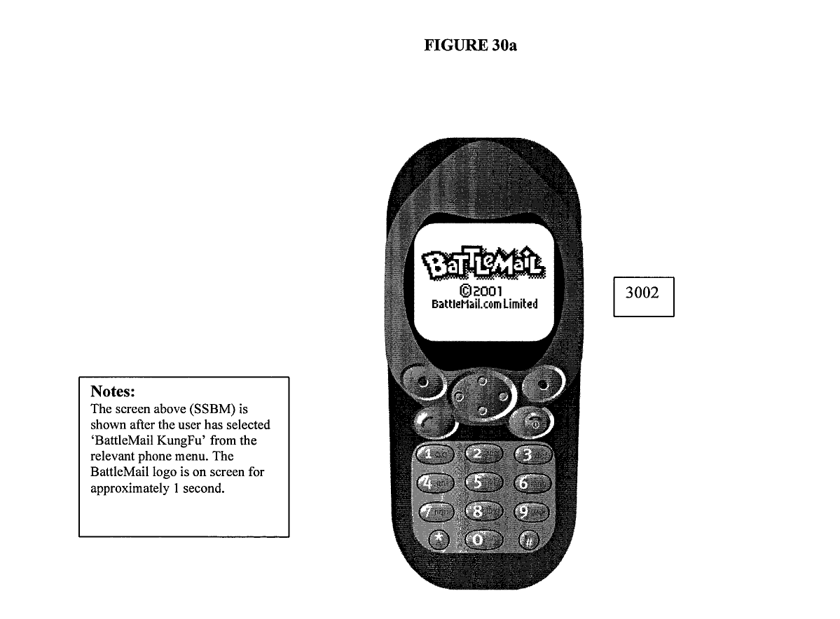

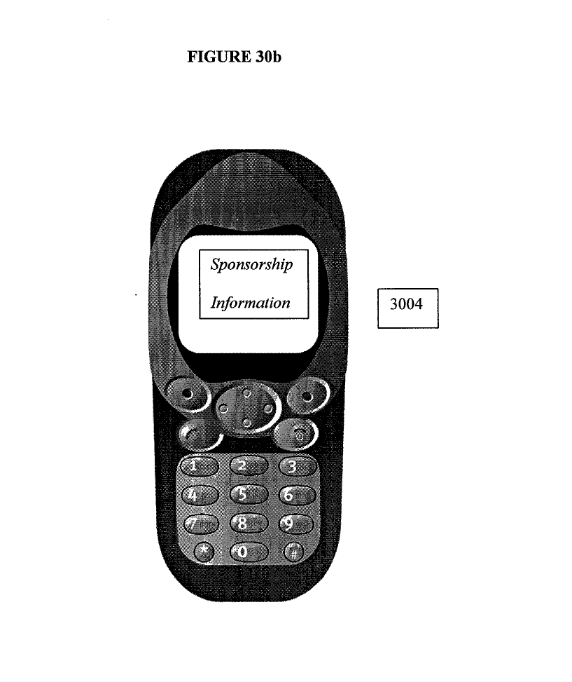

Referring to FIGS. 30a, 30b and 30c there are shown various different screen images 3002, 3004 and 3006 that are sequentially displayed on the screen 2802 of the mobile communication device 2800, 2900 upon invocation of the console software. FIG. 30a is a splash-screen and FIG. 30b is optionally provided to allow, for example, third party sponsorship images to be displayed. It can be appreciated from FIG. 30c that there is presented within the display 2802 a menu 3008 which is traversed using the up and down keys 2904 and 2906. It can be seen that the “Send a Challenge” option is currently highlighted. A user selects the currently highlighted object by depressing the confirmation key 2916. If the user invokes the “Send a Challenge” option, a sequence of screens and instructions follow for collating data from the user. In a preferred embodiment the collated data relates to game data to be processed by the remote data processing apparatus 2604. Preferably, the collated data represents data relating to competitive actions under taken by a character selected by the user of the mobile phone.

Referring to FIGS. 31a and 31b there is shown a flow chart 3100 for issuing a challenge according to an embodiment of the present invention. At step 3102 a registration process is undertaken if the user of the computer or mobile communication device has not used that computer or device to implement an embodiment of the present invention. The registration process involves collating data relating to the user of the mobile phone such as age, sex, interests etc to allow a user profile to be constructed and stored within remote data processing system. Assuming the initial registration process shown in step 3102 has been undertaken, a user, at step 3104, selects a character using the keypad 2830, that is, having selected the “Send a Challenge” option 3010, the screen 2802 of the mobile communication device displays one of a number of character selection images as shown in FIG. 32. Preferably, the characters are selected by cycling through them, as indicated by the arrows 3202 and 3204, using the left and right keys 2908 and 2910 respectively. The user selects a character by depressing the confirmation key 2914. Having selected a character at step 3104, processing proceeds to step 3106 where the user can enter a range of attacking moves for the selected character. The mobile communication device displays an image such as shown in FIG. 33 via which six attacking moves 3300 can be sequentially entered. Each attacking move is designated as being a high, medium or low attacking move using the up 2904 and down 2906 keys. While the type of move is being selected, a corresponding image 3302 is displayed on the left hand side of the display screen 2802. The moves 1 to 6 are selected using the left and right keys 2908 and 2910 respectively. Once all attacking moves have been entered, the attacking moves are confirmed by pressing the confirmation key 2914.

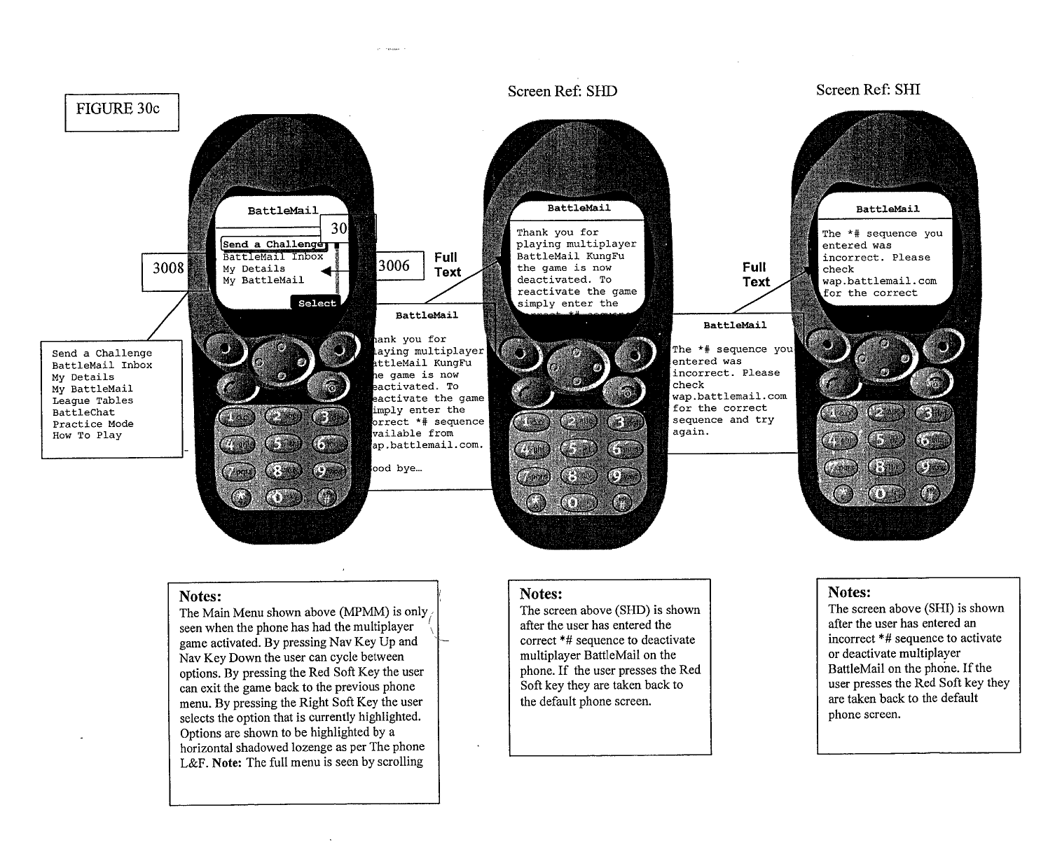

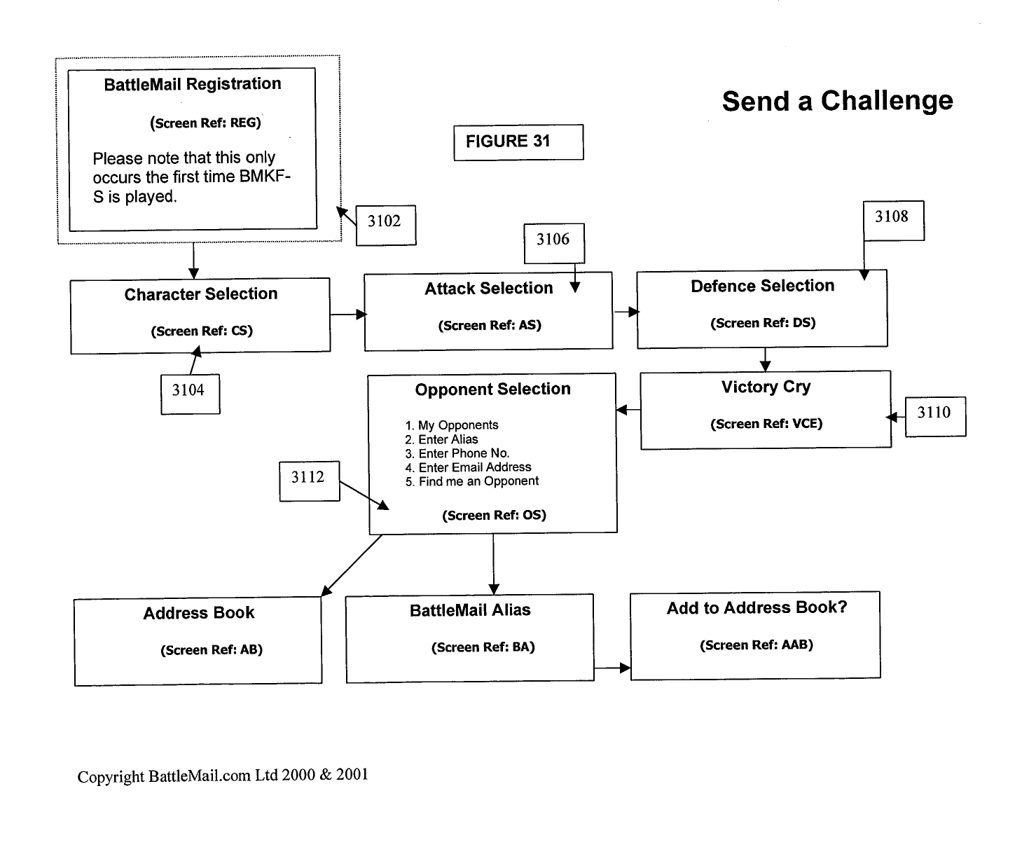

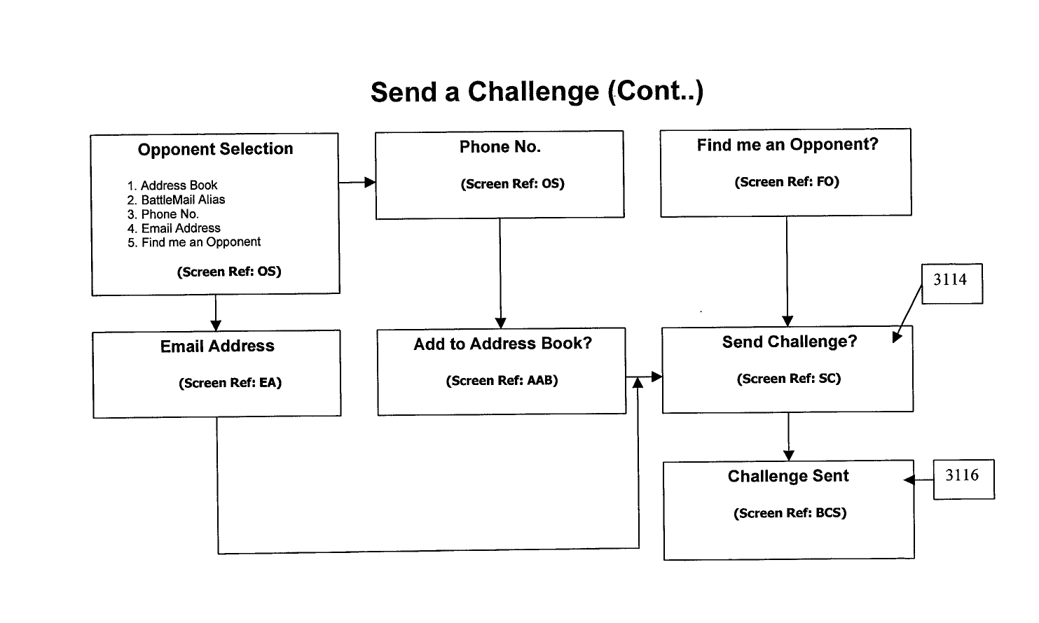

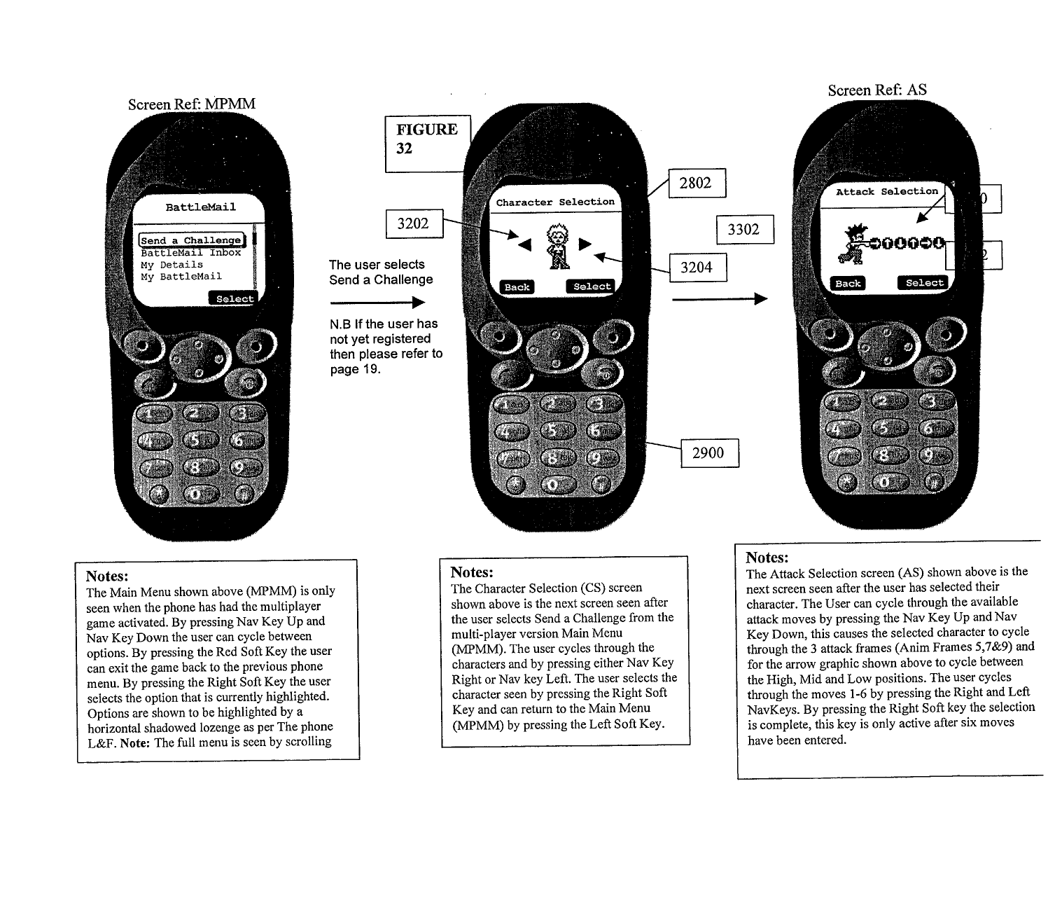

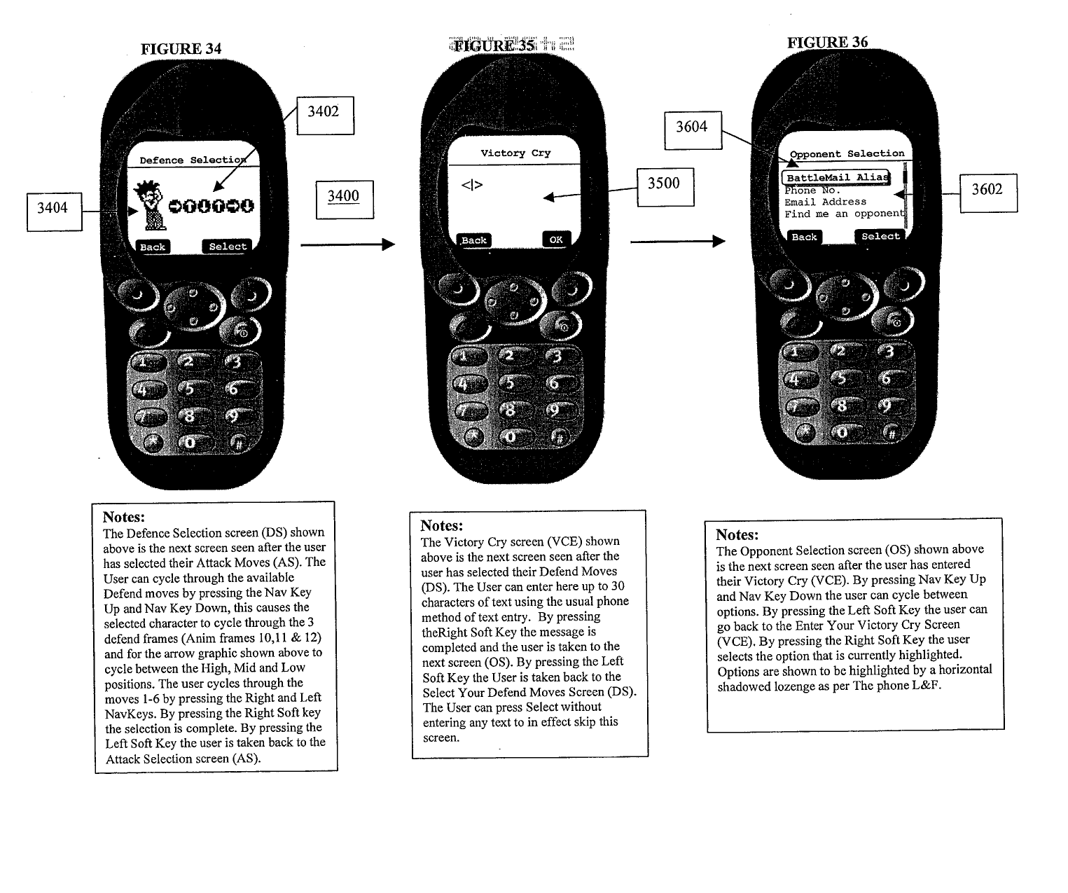

Referring back to FIG. 31, once the confirmation key 2914 has been depressed, control passes to step 3108 where a screen 3400 as shown in FIG. 34 for selecting the defensive moves is displayed. In a manner substantially similar to that described above in relation to FIG. 33 for the selection of the attacking moves, the user can select a range of six defensive moves 3402 using the up, down, left and right keys. Again, an image 3404 for each of the defensive moves is displayed as the user cycles through the various possible moves. The user confirms the selection of the defensive moves using the confirmation key 2914. Should the user wish to revert to an earlier step of the flowchart shown in FIG. 31 at any stage, the left key 2912 will take the user back to the previous stage in the flowchart.

Having entered the defensive moves at step 3108, control passes to step 3110 where the user is invited to enter a victory cry as can be appreciated from screen 3500 of FIG. 35. The “enter a victory cry” screen 3500 enables the user to enter a message to be displayed to an opponent in the event of victory. In an embodiment, the victory cry is input and output as a string of characters. The text characters of the victory cry are entered in the conventional manner as is well known within the art using, for example, the lettered keys of the keypad. Once the victory cry message has been completed, the confirmation key 2914 is depressed indicate to the console software that the entry of the victory cry message has been completed. If the user, at this stage, presses the left key 2912, control passes to step 3108 where the defensive moves can be re-selected or altered. Optionally, if the user presses the confirmation key 2914 without entering any text characters, a victory cry, in the event of victory, will not be displayed to an opponent.

An opponent is selected at step 3112 as shown in FIG. 36 where the opponent can be determined from anyone of five menu 3620 options. The various menu options 362 are traversed using the up and down keys. A currently selected menu item is highlighted as is shown for the address book 3604 entry. Preferably, there are various method of selecting a potential opponent which include, for example, a list of potential or previous opponents that have been stored in an address book, a list of potential opponents for which an email address is stored within an address book, a telephone number of a person to be challenged and, in an embodiment, the opponent is selected by the remote data processing system by, for example, matching the user profile of the user with a user profile of another user stored within the data bases of the remote data processing system 2604.

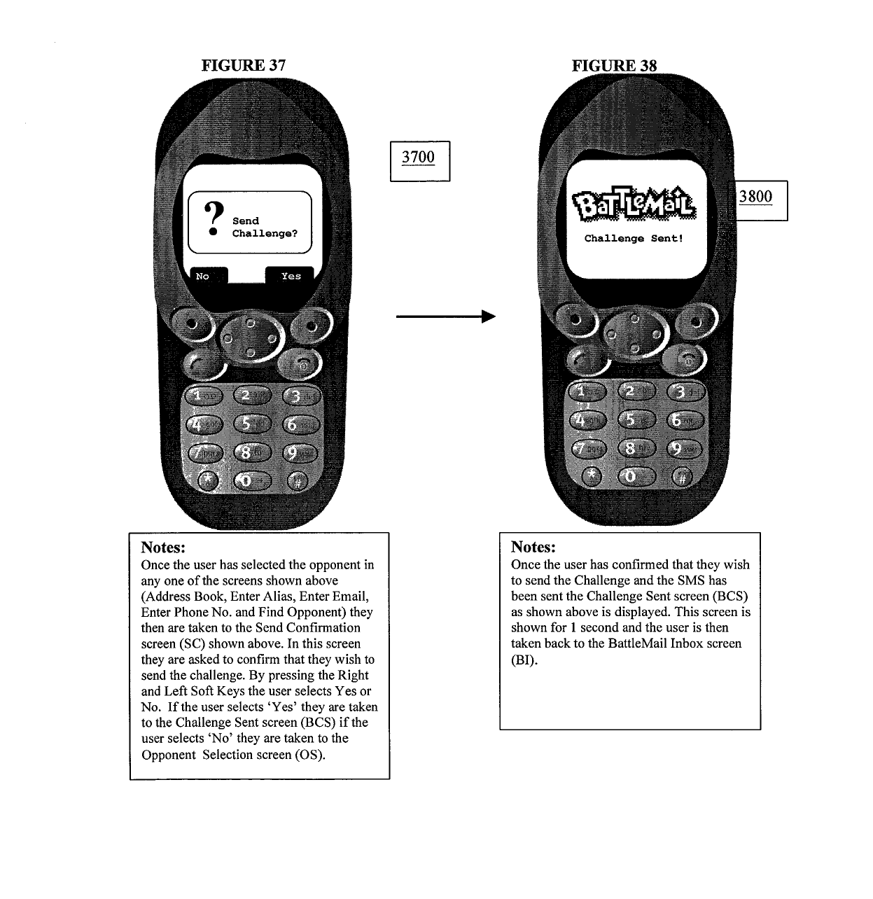

Once an opponent has been selected at step 3112, control transfers to step 3114 where, as can be appreciated from FIG. 37, the user is asked to indicate whether or not the challenge should be sent. The user selects the options “yes” or “no” displayed on the screen 2802 using the right and left keys 2912 and 2914. If the user selects the “yes” option, the data collated by the console software 2804 is placed in a message having a format as indicated above by message type 1 and the message, containing the data collated by or generated by the console software, is placed in the outbox 2833 for subsequent transmission by the messaging system 2816 to the SMS centre 2606. Once the challenge has been sent, the mobile communication device outputs a screen image 3800 as shown in FIG. 38 providing an indication to that effect.

As can be appreciated from FIG. 31 the challenge is sent, that is, the data message 2822 together with the console generated data 2824 is sent to the SMS centre at step 3116.

Referring back to FIG. 28, it can be appreciated that a challenge or the results of a game is received via a received message 2818 and associated console data 2820 which enters the messaging system 2816 and is then forwarded to the non-volatile inbox 2832 associated with the console software 2804. There will now be described the processing undertaken by the console software in the event of receipt of such a message 2818. When a challenge or fight SMS is received by the mobile communication device, a distinctive ring associated with any such receipt is output via the speaker 2812. The SMS header and BM-header are used to determine whether or not the incoming message 2818 is conventional text message or a message destined to be processed by the console software 2804. If it is determined that the received message 2818 is a conventional test message, the message is processed in the usual manner. However, if it is determined that the received message 2818 is a message intended for further processing by the console software 2804, that message is stored within the inbox 2832 associated with the console software 2804.

### ACCEPTING A CHALLENGE

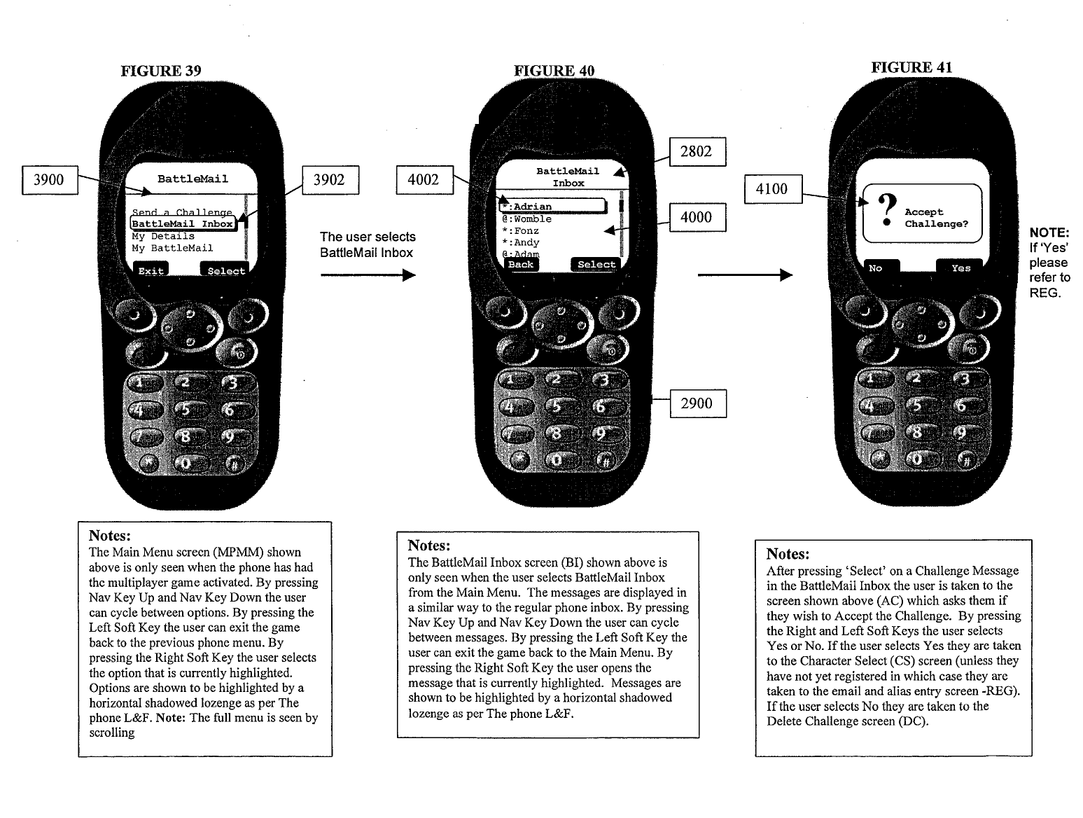

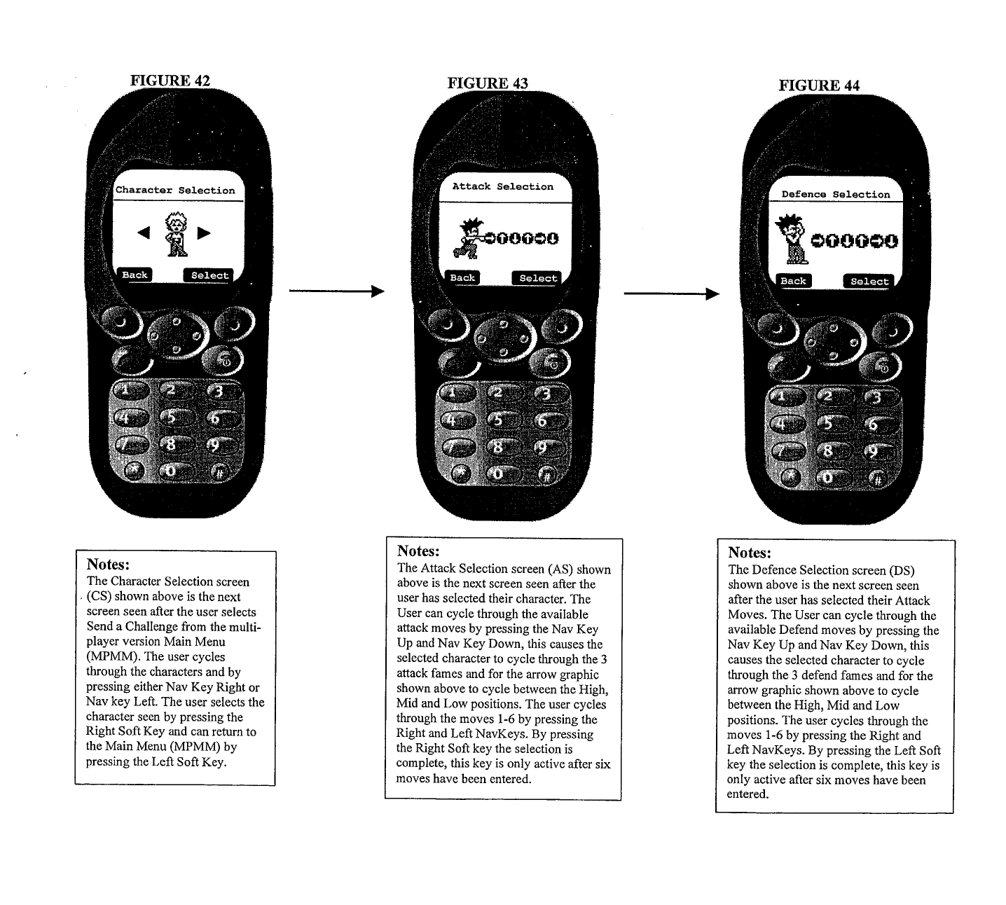

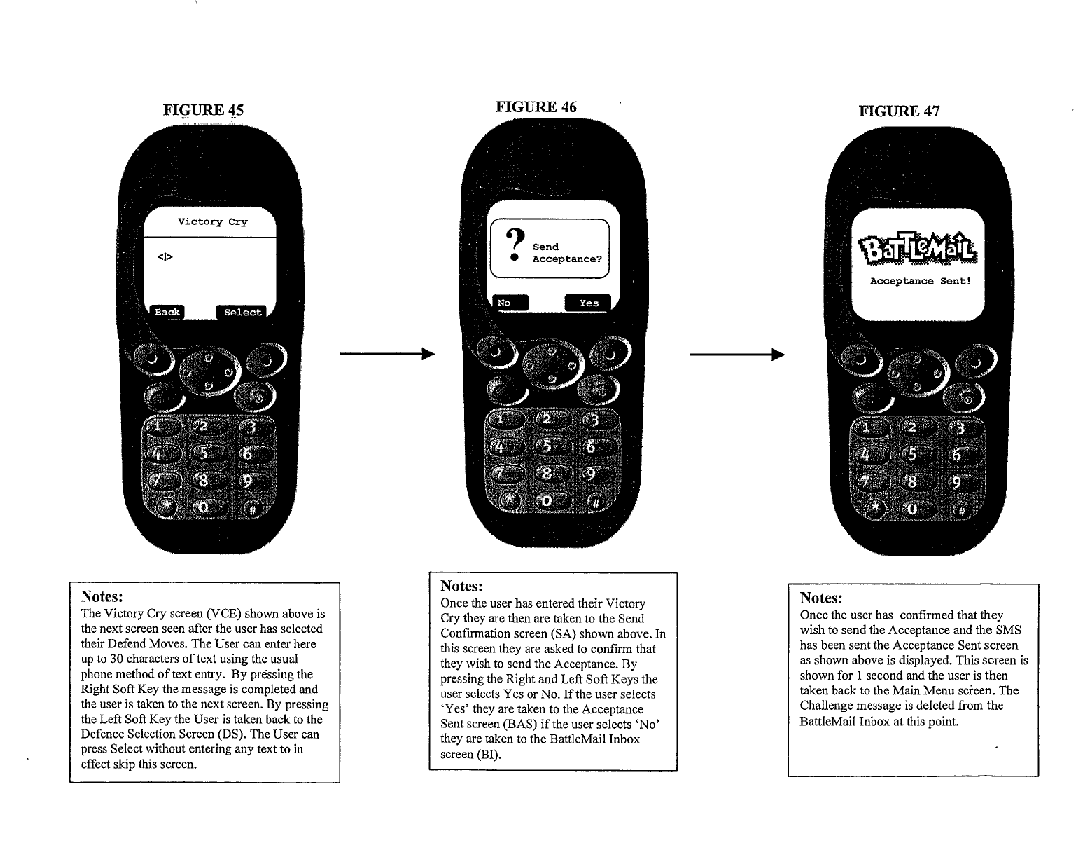

A user of the mobile phone may, having previously invoked the console software 2804, via the menu shown in FIG. 39, issue a challenge via the “Send a Challenger”option 3900, in a manner substantially as described above with reference to FIGS. 29 to 38, or examine the content of the inbox 2832 via a “Battlemail inbox” menu option 3902 to determine whether any challenges or fight results have been received. Having selected the second 4102 menu item, a number of messages 4000 which stored within the inbox 2832 are displayed on the screen 2802 of the mobile communication device 2900 as can be appreciated from FIG. 40. It can be appreciated from FIG. 40 that the first menu item 4002 is the currently selected item. The messages 4000 contained within the inbox 2832 are traversed using the up and down keys 2904 and 2906 and a menu item is selected, again, using the confirmation key 2916. Referring again to FIG. 40, it can be appreciated that each element within the menu list 4000 comprises an identifier, via which the identity of a challenger or opponent can be determined. Each menu item 4000 also has an associated field that provides an indication as to whether the incoming message relates to a challenge issued by a third person or the results of combat between selected character issued by the remote server 2604. Having selected a message, if the message relates to an incoming challenge, as can be determined from the message type, the screen 4100 shown in FIG. 41 is output to request the user of the mobile phone 2900 to indicate whether or not they wish to accept the challenge. A challenge is accepted or declined by selecting the “yes” or “no” keys 4102 and 4104 using the navigation keys together with the confirmation key 2914. If the user declines the challenge, the user is returned to the screen shown in FIG. 40. However, if the user accepts a challenge, the user is invited to select a character, input attacking and defensive moves, input a corresponding victory cry and to issue an acceptance of the received challenge as can be appreciated from FIGS. 42 to FIG. 47. It will be appreciated by those skilled in the art that FIG. 42 to 47 correspond in operation and look to FIGS. 31 to 38 and therefore need not be described in detail. The features and actions involved in issuing a challenge as described above are also applicable in relation to the corresponding features and actions of accepting a challenge. Once the data for responding to a challenge has been collated, the console software 2804 places a message, for transmission by the messaging system 2816, in the outbox 2833. The messaging system 2816 produces a transmit message 2822 comprising the data 2824 generated or collated by the console software 2804 and arranges for the transmit message 2822 together with the console data 2824 to be transmitted to the SMS centre 2606 where it is ultimately forwarded to and processed by a server 2604.

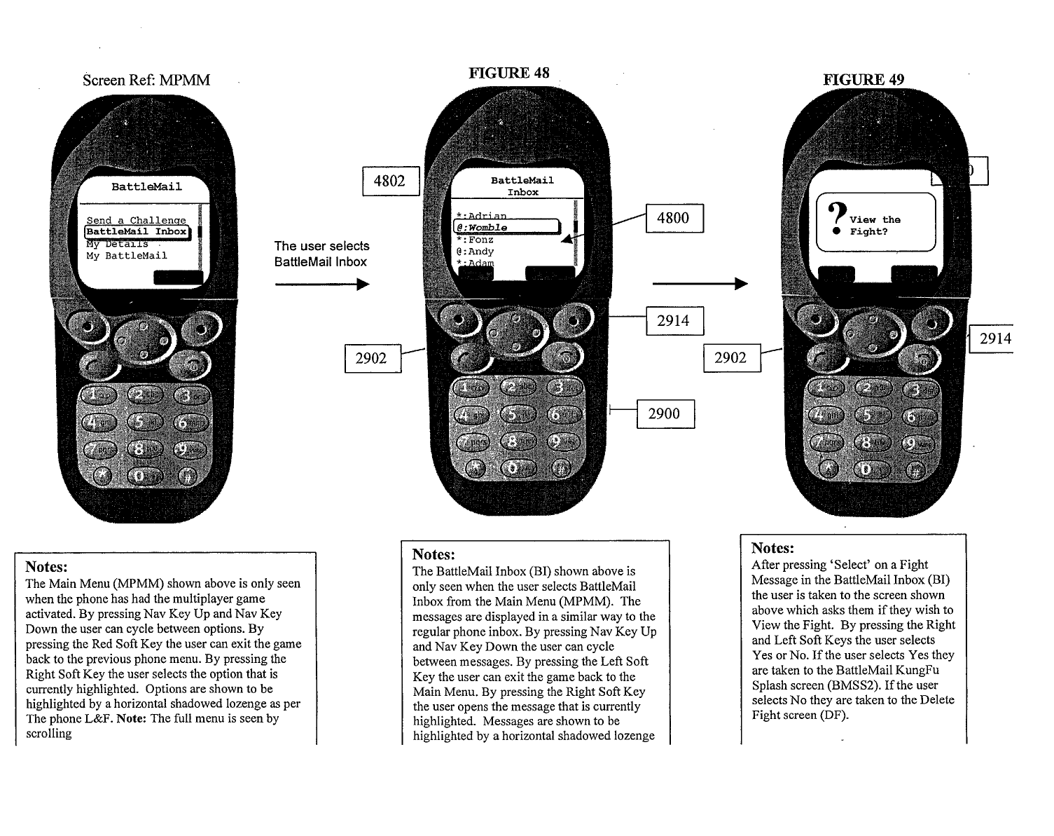

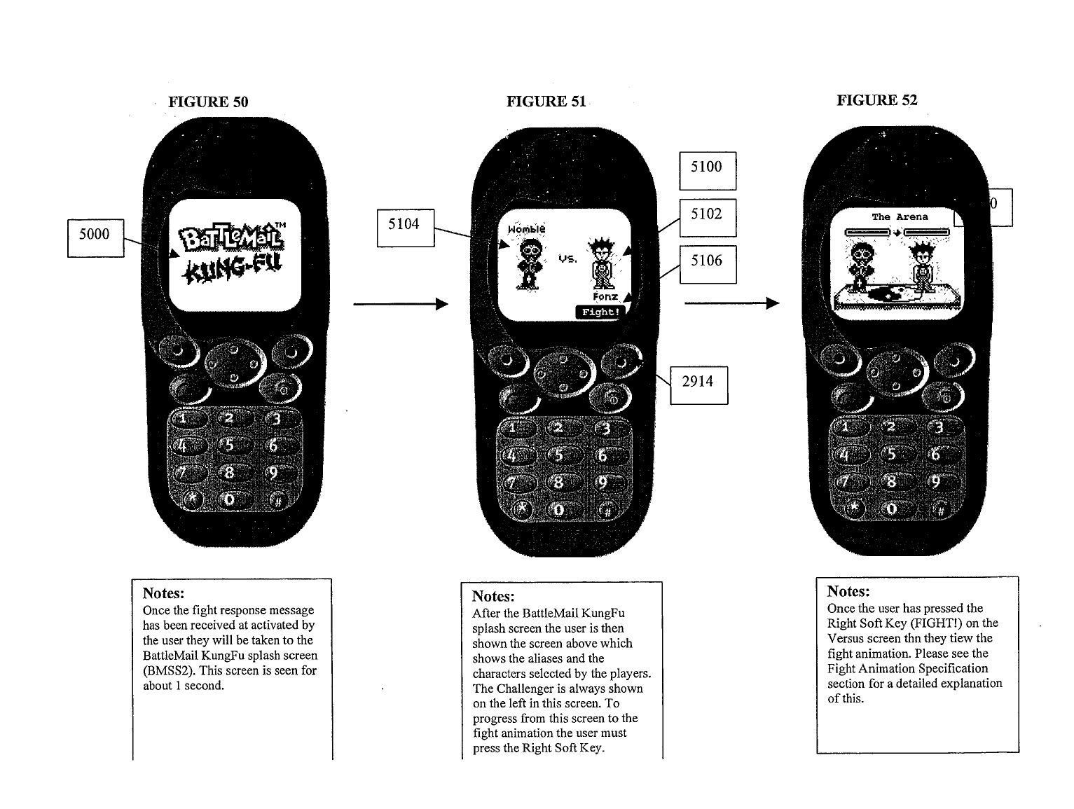

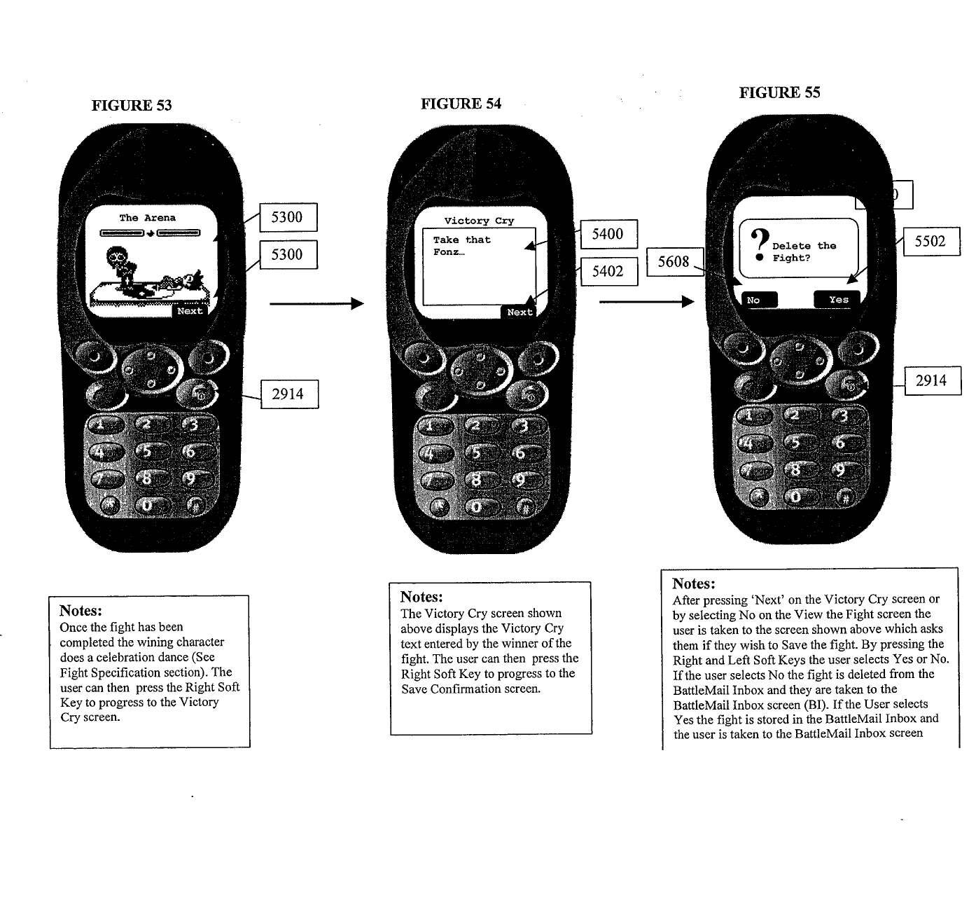

Referring to FIG. 48 there is shown a further view of a mobile communication device 2900 illustrating a number of menu items 4800 of which one menu item is “Womble:fight” 4802 which indicates that the message within the inbox 2832 comprises the results of combat between a character selected by the user of the mobile device 2900 and a participant having an alias “Womble”. It will be appreciated that the SMS/e-mail gateway will map outgoing messages from the game server 2604 which uses aliases such as, for example, “Womble”, to an appropriate telephone number. The user traverses the menu 4800 using the above-described navigation keys and selects an entry using the confirmation key 2914. Selecting the “Womble:fight” entry 4802 takes the user to a screen 4900 as shown in FIG. 49 where the user is asked to indicate whether or not they wish to view the game results, that is, the results of the server 2604 having processed data previously supplied by a challenger and an opponent via “no” and “yes” keys 4902 and 4904 respectively. The “yes” and “no” keys are selected using the navigation keys in conjunction with the confirmation key 2914. If the user selects the “no” option 4902, the user is returned to the inbox as shown in FIG. 48. However, if the user selects the “yes” option 4904, the fight is played out on the screen of the mobile device as can be appreciated from FIGS. 50 to 29. It will be appreciated that FIG. 50 is a title page 5000 or splash screen that is displayed for about 1 second before the image 5100 shown in FIG. 51 is displayed. The image 5100 shown in FIG. 51 displays the characters 5102 and 5104 that will be party to the fight. The fight is commenced by selecting the “Fight!” key 5106 using the confirmation key 2914. Invoking the “Fight!” key 5106 takes the user to the Arena screen 2700 as shown in FIG. 27 where the fight sequence is played out and in which each character 5102 and 5104 performs their respective attacking and defensive moves. At the end of the fight sequence, as shown in FIG. 53, an image 5300 of the victor performing a celebration dance is illustrated and, as can be seen from FIG. 54, upon selecting the “Next” key, using the confirmation key 2914, takes the user of the mobile device to a screen 5400 via which the victory cry is illustrated. A “Next” 5402 key is provided to allow the user, as can be seen from FIG. 55, to progress to a screen which requests the user to indicate whether or not they wish to save the fight. In FIG. 55 the “Save the fight?” screen 3000 comprises “yes” 5502 and “no” 5504 options that are selected using the navigation keys and the confirmation key 2914. If the user selects the “no” option 5504 the fight is deleted from the inbox 2832 and the user is returned to the main menu as shown in FIG. 30c. If the user selects the “yes” option 5502 the fight is retained within the inbox or some other area of non-volatile storage.

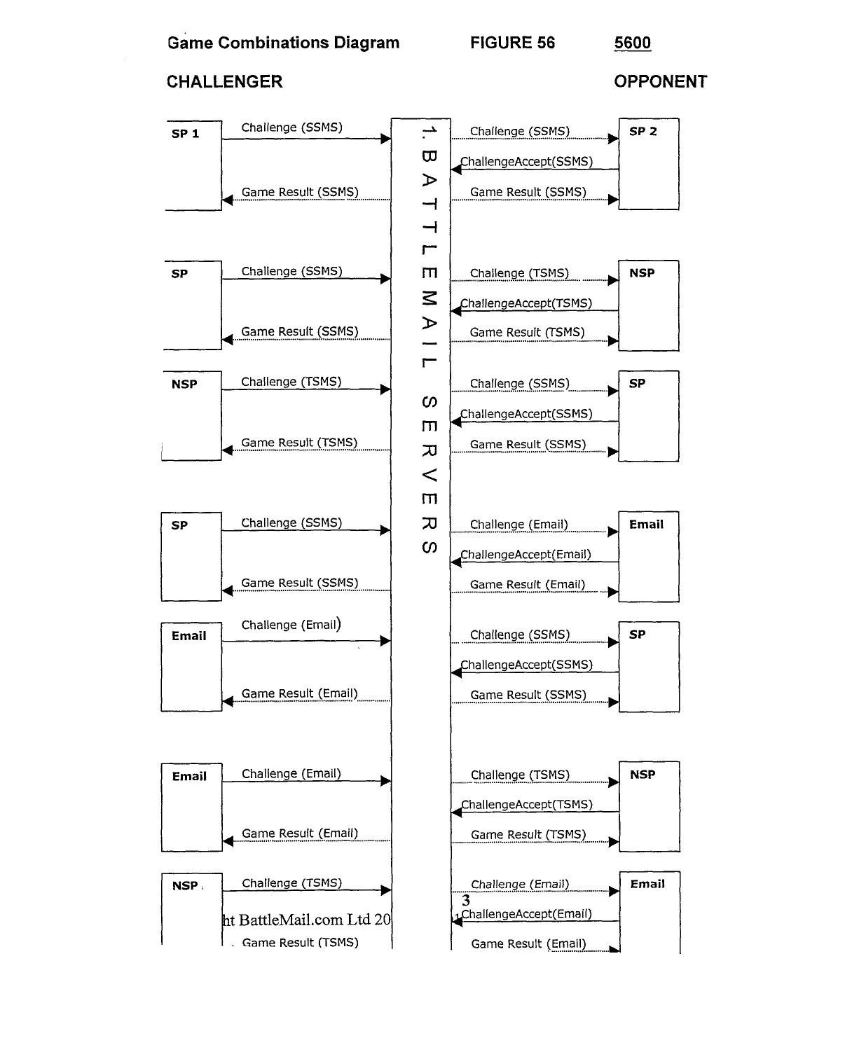

Referring to FIG. 56 there is shown the various game or device combination 5600 that can be realized using embodiments of the present invention. The left-hand side of the diagram lists the platforms which can be used by a challenger and the right-hand side lists the platforms that can be used by an opponent. It can be appreciated that at least three types of platform are contemplated. The first type of platform is a computer which realizes embodiments of the present invention using a mobile telephone 2602 such as that described above, that is, a mobile telephone comprising appropriate console software, which is shown in FIG. 56 by the designation SP, SP1 and SP2. A second type of platform, designated by the legend Email, relates to a PC or computer based platform such as described above via which email together with a corresponding attachment containing the console data is utilized to realize embodiments of the present invention. A third type of platform is mobile communication device, such as a conventional mobile telephone, which supports only conventional SMS text messaging and which does not have console software in accordance with an embodiment of the present invention. The third type of platform is designated by the legend NSP.

It can be appreciated that various business models can be realized in relation to the above described embodiments. For example, it is not uncommon for a network operator to levy a charge on a per SMS message or data message basis. Suitably, an embodiment provides for a commission to be paid by the network operator to a provider of the console software calculated on the utilisation of the network as a consequence of the embodiments of the present invention.

The above embodiments have been realized using email based message exchange and SMS based message exchanges. However, the present invention is not limited thereto. It can be appreciated that, for example, WAP server could be used to both receive any messages and to disseminate the results of processing the data contained within the messages. The PC based embodiments can alternatively or additional utilize a web-server and the mobile based embodiments may use a WAP-server. It will also be appreciated that the mobile based embodiment and the PC based embodiments can be integrated as shown in FIG. 27 to allow or support cross-platform exchanges.

Although the embodiments of the present invention have been described in terms of a mobile phone, the present invention is not limited thereto. Embodiments can be realized in which the mobile communication device is any wireless communication device such as a laptop together with appropriate telephony connection, a personal data assistant with an appropriate telephony connection which supports a data service such as, for example, a messaging service.

Although the above embodiments have been described with reference to an attachment, that is a BMD file, containing the data relating to the participants, the present invention is not limited thereto. An embodiment can be realized in which the data is immediately incorporated into message body of the communication, that is, email, itself and the Battlemail software console monitors incoming email and extracts the data from relevant incoming emails.

Furthermore, the embodiments described herein refer to disseminating information via advertisements. However, it will be appreciated that embodiments can be realized in which the information relates to branding and brand names rather than to any particular type of product or services. Therefore, the information conveyed above, that is, the information retrieved by the servers to be incorporated within the messages sent to a challenger and/or recipient is not limited to advertisements. Branding information can equally well be supplied via embodiments of the present invention. In effect, embodiments of the present invention envisage some form of sponsorship arrangement in which branding of a third party is disseminated as opposed to advertisement information.

What is claimed is:

1. A data processing method comprising the steps of
receiving a first electronic communication addressed to a first addressee containing first data comprising an electronic address of a second addressee;
extracting the electronic address of the second addressee from the first data of the first electronic communication;
creating a second electronic communication addressed to the second addressee comprising data representing graphical information to be displayed to the second addressee; and
sending the second electronic communication to the second addressee using the extracted electronic address of the second addressee.

2. A data processing method as claimed in claim 1 in which the first addressee is a data processing system, such as, for example, a Domain Name Server or a remote server.

3. A data processing method as claimed in any preceding claim in which the first and/or second electronic communication is/are an email.

4. A data processing method as claimed in any preceding claim in which the data representing graphical information comprises third party advertising information.

5. A data processing method as claimed in any preceding claim in which the data representing graphical information varies with time

6. A data processing method as claimed in any preceding claim in which the first data comprises attribute data representing at least one attribute of the sender of the first electronic communication or at least one attribute of the second addressee.

7. A data processing method as claimed in any preceding claim further comprising the step of selecting the data representing graphical information from a plurality of data each representing respective graphical information.

8. A data processing method as claimed in claim 7, further comprising the step of matching the at least one attribute with at least one of the plurality of data each representing respective graphical information, and wherein the step of creating the second email incorporates into the second electronic communication said at least one of the plurality of data representing graphical information as the graphical information to be displayed to the second addressee.

9. A data processing method as claimed in any preceding claim in which the data processing method is a method of advertising.

10. A data processing method as claimed in any preceding claim further comprising the step of receiving the second electronic communication; extracting the data representing graphical information and outputting the data representing graphical information via an output device.

11. A data processing method as claimed in any preceding claim further comprising the steps of creating and sending the first electronic communication to the first addressee containing the first data comprising the electronic address of the second addressee.

12. A data processing method substantially as described herein with reference to and/or as illustrated by the accompanying drawings.

13. A data processing system comprising
means for receiving a first electronic communication addressed to first addressee containing first data comprising an electronic address of a second addressee;
means for extracting the electronic address of the second addressee from the first data of the first electronic communication;
means for creating a second electronic communication addressed to the second addressee comprising data representing graphical information to be displayed to the second addressee; and
means for sending the second electronic communication to the second addressee using the extracted electronic address of the second addressee.

14. A data processing system as claimed in claim 13 in which the first addressee is a data processing system, such as, for example, a Domain Name Server.

15. A data processing system as claimed in any of claims 13 to 14 in which the electronic communication is an email.

16. A data processing system as claimed in any of claims 13 to 15 in which the data representing graphical information comprises third party advertising information.

17. A data processing system as claimed in any preceding claim in which the data representing graphical information varies with time

18. A data processing system as claimed in any of claims 13 to 17 claim in which the first data comprises attribute data representing at least one attribute of the sender of the first electronic communication or at least one attribute of the second addressee.

19. A data processing system as claimed in any preceding claim further comprising means for selecting the data representing graphical information from a plurality of data each representing respective graphical information.

20. A data processing system as claimed in claim 19, further comprising means for matching the at least one attribute with at least one of the plurality of data each representing respective graphical information, and wherein the means for creating the second email incorporates into the second electronic communication said at least one of the plurality of data representing graphical information as the graphical information to be displayed to the second addressee.

21. A data processing system as claimed in any of claims 13 to 20 further comprising means for receiving the second electronic communication; means for extracting the data representing graphical information and means for outputting the data representing graphical information via an output device.

22. A data processing system as claimed in any of claims 13 to 21 further comprising means for creating and sending the first electronic communication to the first addressee containing the first data comprising the electronic address of the second addressee.

23. A data processing system substantially as described herein with reference to and/or as illustrated by the accompanying drawings.

24. A computer program product comprising a computer readable storage medium having stored thereon
computer program code means for receiving a first electronic communication addressed to first addressee containing first data comprising an electronic address of a second addressee,
computer program code means for extracting the electronic address of the second addressee from the first data of the first electronic communication;
computer program code means for creating a second electronic communication addressed to the second addressee comprising data representing graphical information to be displayed to the second addressee; and
computer program code means for sending the second electronic communication to the second addressee using the extracted electronic address of the second addressee.

25. A computer program product as claimed in claim 24 in which the first addressee is a data processing system, such as, for example, a Domain Name Server.

26. A computer program product as claimed in any of claims 24 to 25 in which the electronic communication is an email.

27. A computer program product as claimed in any of claims 24 to 26 in which the data representing graphical information comprises third party advertising information.

28. A computer program product as claimed in any preceding claim in which the data representing graphical information varies with time

29. A computer program product as claimed in any of claims 24 to 28 claim in which the first data comprises attribute data representing at least one attribute of the sender of the first electronic communication or at least one attribute of the second addressee.

30. A computer program product as claimed in any of claims 24 to 29 further comprising computer program code means for selecting the data representing graphical information from a plurality of data each representing respective graphical information.

31. A computer program product as claimed in claim 30, further comprising computer program code means for matching the at least one attribute with at least one of the plurality of data reach representing respective graphical information, and wherein the computer program code means for creating the second email incorporates into the second electronic communication said at least one of the plurality of data representing graphical information as the graphical information to be displayed to the second addressee.

32. A computer program product as claimed in any of claims 24 to 31 further comprising computer program code means for receiving the second electronic communication; computer program code means for extracting the data representing graphical information and computer program code means for outputting the data representing graphical information via an output device.

33. A computer program product as claimed in any of claims 24 to 32 further comprising computer program code means for creating and sending the first electronic communication to the first addressee containing the first data comprising the electronic address of the second addressee.

34. A computer program product substantially as described herein with reference to and/or as illustrated by the accompanying drawings.

35. A computer program element comprising
computer program code means for receiving a first electronic communication addressed to first addressee containing first data comprising an electronic address of a second addressee,
computer program code means for extracting the electronic address of the second addressee from the first data of the first electronic communication;
computer program code means for creating a second electronic communication addressed to the second addressee comprising data representing graphical information to be displayed to the second addressee; and
computer program code means for sending the second electronic communication to the second addressee using the extracted electronic address of the second addressee.

36. A computer program element as claimed in claim 35 in which the first addressee is a data processing system, such as, for example, a Domain Name Server.

37. A computer program element as claimed in any of claims 35 to 36 in which the electronic communication is an email.

38. A computer program element as claimed in any of claims 35 to 37 in which the data representing graphical information comprises third party advertising information.

39. A computer program element as claimed in any of claims 35 to 38 in which the data representing graphical information varies with time

40. A computer program element as claimed in any of claims 35 to 39 claim in which the first data comprises attribute data representing at least one attribute of the sender of the first electronic communication or at least one attribute of the second addressee.

41. A computer program element as claimed in any of claims 35 to 40 further comprising computer program code means for selecting the data representing graphical information from a plurality of data each representing respective graphical information.

42. A computer program element as claimed in claim 41, further comprising computer program code means for matching the at least one attribute with at least one of the plurality of data reach representing respective graphical information, and wherein the computer program code means for creating the second email incorporates into the second electronic communication said at least one of the plurality of data representing graphical information as the graphical information to be displayed to the second addressee.

43. A computer program element as claimed in any of claims 35 to 42 further comprising computer program code means for receiving the second electronic communication; computer program code means for extracting the data representing graphical information and computer program code means for outputting the data representing graphical information via an output device.

44. A computer program element as claimed in any of claims 35 to 43 further comprising computer program code means for creating and sending the first electronic communication to the first addressee containing the first data comprising the electronic address of the second addressee.

45. A computer program element substantially as described herein with reference to and/or as illustrated by the accompanying drawings.

46. A data processing system comprising
means for creating an outgoing email addressed to a remote server, the email having an attachment containing first data to be processed in an operation at the remote server and data representing a third party email address;
means for receiving from the remote server an incoming email comprising an attachment containing second data representing the results of processing the first data; and
means for displaying graphically the results of the processing.

47. A data processing system comprising
means for receiving from a first party an incoming email having an attachment containing first data to be processed in an operation at the data processing system and data representing a third party email address;
means for creating a first outgoing email addressed to the third party having an attachment comprising second data identifying the first party from which the incoming email was received;
means for receiving from the third party an email comprising an attachment having third data to be processing in the operation at the data processing system;
means for processing the first data and the third data to produce data processing results; and means for creating a second outgoing email having an attachment comprising the data processing results;
and means for sending the second outgoing email to at least one of the first party and third party.

48. A data processing system as claimed in claim 47 comprising means for retrieving from a data base information relating to a fourth party and means for including the retrieved information in the data of the attachment to at least one of the first outgoing email and the second outgoing email.

49. A data processing system as claimed in claim 48 comprising means for selecting the retrieved information from a plurality of information.

50. A data processing system as claimed in claim 49 in which the means for selecting is responsive to characteristics associated with at least one of the first party and the third party.

51. A data processing system as claimed in claim 48 or 49 in which the means for selecting is responsive to the time at which the first email was received.

52. A data processing system as claimed in claims 48 to 51 in which the means for selecting is responsive to the time at which the second outgoing email was created.

53. A data processing system comprising
means for receiving from a remote server a first email having an attachment comprising first data identifying a third party;
means for creating a first outgoing email containing second data to be processed in an operation at the remote server; and
means for sending the first outgoing email to the remote server.

54. A method of advertising comprising creating an outgoing email containing an attachment having data representing an advert of a vendor; and sending the email to at least one of a first party and a second party in response to having received an email from at least one of the first party and the second party.

55. A method of advertising as claimed in claim 54 comprising selecting the data representing the advert from a data base containing a plurality of data representing respective adverts.

56. A method of adverting as claimed in claim 55 in which the step of selecting comprises selecting the data presenting an advert from the plurality of data according to characteristics associated with at least one of the first party and the second party.

57. A method of advertising as claimed in claims 55 or 56 in which the step of selecting comprises selecting the data representing the advert from the plurality of data according to the time of day.

58. A method of adverting as claimed in any of claim 54 to 57 further comprising making a charge to the vendor for sending an email containing the vendor's advertisement.

59. A data processing system substantially as described herein with reference to and/or as illustrated in the accompanying drawings.

60. An advertising method substantially as described herein with reference to and/or as illustrated in the accompanying drawings.

61. A data processing system or method for implementing an advertising method as claimed in any of claims 54 to 60.

62. A system or method as claimed in any preceding claim in which the data of an attachment comprises data representing a game and the system or method further comprising means for or the step of varying the game by selecting the game from a plurality of games.

63. A data processing method for a data processing system comprising at least a first console device for executing a first console software, at least a second console device for executing a second console software, at least one message exchange apparatus for exchanging messages with the at least first and second console devices, at least one data processing apparatus for processing data contained within the messages received by the message exchange apparatus from the at least first and second console devices, the first and second console devices further comprising respective input means for influencing the operation of the first and second console software and respective output devices for outputting processing results of activities performed by the first and second console software; the method comprising the steps of
transmitting, from the first console device to the message exchange apparatus, a first message comprising first data generated, in response to input received via an input means, by the first console software;
receiving, at the message exchange apparatus, the first message transmitted from the first console device; transmitting, from the second console device to the message reception apparatus, a second message comprising second data generated, in response to inputs received via an input means, by the second console software product;
receiving, at the message exchange apparatus, the second message transmitted from the second console device; processing, at the data processing apparatus, the first and second data contained within the first and second messages to produce results data for processing by the first and second console software;
creating a response message for transmission to the first and second console devices comprising the results data; transmitting the response message to the first and second console devices;
receiving the response message at the first console device and processing, by the first console software, the results data within the response message; and outputting the result of processing the results data to least one output device of the first console device;
receiving the response message at the second console device and processing, by the second console device software, the results data within the response message; and outputting the result of processing the results data to at least one output device of the second console device.

64. A method as claimed in claim 63 in which the processing, by the data processing apparatus, comprises identifying corresponding data within the first and second data and producing a first result data, of the results data, representing at least one of an interaction between and a combination of the first and second data.

65. A method as claimed in of claims 63 to 64 in which the step of transmitting the first message comprises the step of creating a first file containing the first data for attachment to the first message to be transmitted to the message exchange apparatus; and transmitting the first message to the message exchange apparatus together with the first file as an attachment.

66. A method as claimed in any of claims 63 to 65 in which the step of transmitting the second message comprises the step of creating a second file containing the second data for attachment to the second message to be transmitted to the message exchange apparatus; and transmitting the second message to the message exchange apparatus together with the second file as an attachment.

67. A method as claimed in any of claims 63 to 66 in which the step of transmitting the first data comprises the step of creating a first data message comprising the first data generated by the first console software for transmission to the message exchange apparatus; and transmitting the first data message to the message exchange apparatus.

68. A method as claimed in any of claims 63 to 67 in which the step of transmitting the second data comprises the step of creating a second data message comprising the second data generated by the second console software for transmission to the message exchange apparatus; and transmitting the second data message to the message exchange apparatus.

69. A method as claimed in either of claims 67 and 68 in which the step of creating the data message comprises the step of creating a text message comprising text generated first console software.

70. A method as claimed in claim 69 in which the text message is an SMS message.

71. A data processing method for a data processing system comprising at least a first console device (first mobile handset) for executing a first console software, at least one message exchange apparatus (SMS gateway) for exchanging messages with at least the first console device, at least one data processing apparatus (game server) for processing data contained within the messages received by the message exchange apparatus (SMS gateway) from at least the first console device, the first console device further comprising input means for influencing the operation of the first console software and output means for outputting processing results of activities performed by the first console software; the method comprising the steps of
transmitting, from the first console device to the message exchange apparatus, a first message comprising first data generated by the first console software, in response to inputs received via the input means;
receiving, at the first console device, a response message comprises results data derived from processing the first data and second data generated by a second console software of a second console device; and
processing, by the first console software, the results data within the response message; and outputting the result of processing the results data to least one output device of the first console device; and
outputting, via the first console software, at least graphical data derived from the results data.

72. A method as claimed in claim 71 in which the step of transmitting the first message comprises the step of creating a first file containing the first data for attachment to the first message to be transmitted to the message exchange apparatus; and transmitting the first message to the message exchange apparatus together with the first file as an attachment.

73. A method as claimed in any of claims 71 to 72 in which the step of transmitting the first data comprises the step of creating a first data message comprising the first data generated by the first console software for transmission to the message exchange apparatus; and transmitting the first data message to the message exchange apparatus.

74. A method as claimed in any of claims 71 to 73 in which the step of creating the data message comprises the step of creating a text message comprising text generated first console software.

75. A method as claimed in claim 74 in which the text message is an SMS message.

76. A method as claimed in any of claims 63 to 75 in which the step of transmitting, from the first console device to the message exchange apparatus, a first message comprising first data generated, in response to input received via an input means, by the first console software comprises the step of
transmitting, from the first console device, a first electronic communication addressed to the message exchange apparatus, the first electronic communication containing first data comprising at least an electronic address of the second console device of a second addressee.

77. A method as claimed in claim 76 further comprising the steps of:
extracting the electronic address of the second addressee from the first data of the first electronic communication.

78. A method as claimed in claim 77 further comprising the steps of
creating, by the message exchange apparatus, a second electronic communication addressed, using the electronic address, to the second console device of the second addressee comprising data to cause the second console software to generate an output via the output means of second console device; and
transmitting the second electronic communication to the second console device using the extracted electronic.

79. A method as claimed in any of claims 63 to 78, further comprising the steps of:
receiving, at the second console device, the second electronic communication; and
processing, by the second console software, the data contained within the second electronic communication to produce an output via the output means of the second console device; and
receiving, via the input means of the second console device, inputs for controlling the generation of data for responding to the receipt of the second electronic communication.

80. A method as claimed in claim 79 in which the step of transmitting, from the second console device to the message reception apparatus, a second message comprising second data generated, in response to inputs received via an input means, by the second console software product; Comprises the step of creating, by the second console software, the second data comprising response data for transmission to the message exchange apparatus.

81. A method as claimed in any of claims 79 to 80 in which the step of transmitting the first message comprises the step of creating a first file containing the first data for attachment to the first message to be transmitted to the message exchange apparatus; and transmitting the first message to the message exchange apparatus together with the first file as an attachment.

82. A method as claimed in any of claims 79 to 81 in which the step of transmitting the first data comprises the step of creating a first data message comprising the first data generated by the first console software for transmission to the message exchange apparatus; and transmitting the first data message to the message exchange apparatus.

83. A method as claimed in any of claims 79 to 82 in which the step of creating the data message comprises the step of creating a text message comprising text generated first console software.

84. A method as claimed in claim 83 in which the text message is an SMS message.

85. A method as claimed in any preceding claim in which at least one of the first and second console devices is at least one of a computer or a communication device

86. A method as claimed in claim 85 in which the communication device is a mobile communication device.

87. A method as claimed in claim 86 in which the mobile communication device is at least one of a mobile telephone.

88. A method as claimed in any of claims 63 to 87 in which the message reception comprises at least one of an email server and a mobile communication gateway connected to the data processing apparatus.

89. A method as claimed in claim 88 in which the mobile communication gateway is connected to the data processing apparatus via a communication network.

90. A method as claimed in either of claims 87 and 88 in which the mobile communication gateway is arranged to receive messages from at least one of the first and second console devices.

91. A method as claimed in any of claims 87 to 90 in which the mobile communication gateway is an SMS gateway.

92. A method as claimed in any of claims 87 to 90 in which the data processing apparatus comprises at least one computer for processing the first and second data.

93. A method as claimed in 92 in which the data processing apparatus comprises at least one further computer for processing the first and second data.

94. A method as claimed in any of claims 63 to 93 in further comprising the step of receiving via an input device audio data and in which at least one of the first and second data comprises such audio data.

95. A method as claimed in any of claims 63 to 94 further comprising the step of selecting audio data from a plurality of audio data for inclusion in at least one of the first and second data; and including the selected audio data in said at least one of the first and second data.

96. A method as claimed in claim 95 further comprising the step of storing the plurality of audio data in a format defined by an audio codec.

97. A method as claimed in claim 96 in which the audio codec is at least one of a TDMA, GSM, CDMA and IS-95 audio codec.

98. A method as claimed in claim 95 to 97 in which the step of outputting results data by at least one of the first and second console software further comprises the step of outputting the selected audio data.

99. A data processing method substantially as described herein with reference to and/or as illustrated in the accompanying drawings.

100. A data processing system for implementing a method as claimed in any preceding claim.

101. A computer program element for implementing a system or method as claimed in any preceding claim.

102. A computer program product comprising a computer readable storage medium having stored thereon a computer program element as claimed in claim 101

103. A mobile communication comprising
means for storing operational software and console software,
means for executing operational software,
means for executing console software,
means for transmitting and receiving data messages and memory for storing at least a first type of data message and a second type of data message;
means for determining whether a received data message is a first type of data message or a second type of data message; and
means for processing the data message using console software to output a plurality of graphical images in response to the data contained within the data message if the data message is a second type of data message.

104. A mobile communication device as claimed in claim 103 in which the means for determining comprises means for routing the received data message to second area of memory accessible by the microprocessor in response to executing the console software if the data message is a second type of data message and routing the data message to the first area of memory if the data message is a second type of data message.

105. A mobile communication device as claimed in any of claims 103 to 105 in which the means for processing the first type of data message comprises means for outputting on the display a character message derived from the data contained within the data message.

106. A mobile communication device as claimed in any of claims 103 to 105 in which the data contained within the second type of data message comprises data generated by a data processing system in response to receiving at least one data message comprising respective data generated console software of at least one further mobile communication device.

107. A mobile communication device as claimed in any of claims 103 to 106 in which the data contained within the second type of data message comprises data generated by a data processing system in response to receiving and processing a first and second data messages; the data contained within the first data message having been generated, in response to actuation of a respective input means, by respective console software of at least one further mobile communication device and the data contained within the second message having been generated, in response to actuation of the input means, by respective console software of the mobile communication device.

108. A mobile communication device as claimed in any of claims 103 to 107 comprising means for searching through at least one of the first and second areas of memory containing respective messages for messages of the second type and means for outputting an indication of the presence of any located messages of the second type on the display.

109. A mobile communication device as claimed in claim 108 further comprising means, response to actuation of the input means, for processing the data contained within a selectable one of the located second type of data messages.

110. A mobile communication device as claimed in any of claims 103 to 109 in which the data message is an SMS message.

111. A mobile communication device substantially as described herein with reference to and/or as illustrated in the accompanying drawings.

112. A data processing method for a mobile communication device comprising means for storing operational software and console software, means for executing operational software, means for executing console software, means for transmitting and receiving data messages and memory for storing at least a first type of data message and a second type of data message; the method comprising the steps of
storing a received data message in the memory;
determining whether the received data message is a first type of data message or a second type of data message; and
processing the received data message using the operational software or the console software if the received data message is a first or second type of data message respectively.

113. A method as claimed in claim 112 in which the step of processing the received data message using the operational software comprises the steps of outputting a character string derived from data contained within the received data message.

114. A method as claimed in either of claims 112 or 113 in which the step of processing the received data message using the console software comprises the steps of generating a plurality of graphical images using the data contained within the received data message.

115. A method for processing data substantially as described herein with reference to and/or as illustrated in the accompanying drawings.

116. A data processing system for implementing a method as claimed in any of claims 103 to 116.

117. A computer program element for implementing a method or system as claimed in any of claims 103 to 116.

118. A computer program product comprising a storage medium having stored thereon on a computer program element as claimed in claim 117.
